(19) United States
(12) Patent Application Publication
(10) Pub. No.: US 2026/0003935 A1
(43) Pub. Date: Jan. 1, 2026

(54) HIGH PERFORMANCE EXECUTION OF STATE SPACE MODELS ON NEURAL NETWORK ACCELERATORS

(71) Applicant: Intel Corporation, Santa Clara, CA (US)

(72) Inventors: Arnab Raha, San Jose, CA (US); Arghadip Das, San Jose, CA (US); Soumendu Kumar Ghosh, Hillsboro, OR (US); Shamik Kundu, San Jose, CA (US); Deepak Abraham Mathaikutty, Chandler, AZ (US)

(73) Assignee: Intel Corporation, Santa Clara, CA (US)

(21) Appl. No.: 19/329,241

(22) Filed: Sep. 15, 2025

Related U.S. Application Data
(60) Provisional application No. 63/754,751, filed on Feb. 6, 2025.

(51) Int. Cl. G06F 17/16; G06N 3/042

(52) U.S. Cl. CPC G06F 17/16; G06N 3/042

(57) ABSTRACT

State space model (SSM) neural network operations can be executed efficiently on neural network accelerators by mapping sequential aggregation operations to data-parallel hardware. For cumulative sum operations, the neural network accelerator can perform matrix-to-matrix multiplication with a lower-triangular mask to achieve the same result. For reduce sum operations, the neural network accelerator can perform matrix-to-vector multiplication with a vector mask to achieve the same result. These mappings exploit the parallelism in the neural network accelerators, reduce memory traffic, and leverage sparsity compression and compute skipping for efficiency. Additionally, activation functions can be accelerated using programmable look-up tables during the drain phase. The approach achieves significant latency and energy improvements without hardware changes, enabling high performance deployment of SSM-based models on resource-constrained neural network accelerators.

### CROSS-REFERENCE TO RELATED APPLICATION(S)

This application claims priority to and/or receives benefit from U.S. Provisional Application No. 63/754,751, filed on 6 Feb. 2025, titled, EXECUTION OF STATE SPACE MODELS ON NEURAL PROCESSING UNIT. The U.S. Provisional Application is hereby incorporated by reference in its entirety.

### BACKGROUND

Deep neural networks (DNNs) are used extensively for a variety of artificial intelligence (AI) and machine learning (ML) applications ranging from computer vision to speech recognition and natural language processing due to their ability to achieve high accuracy. However, the high accuracy comes at the expense of significant computation cost. DNNs have extremely high computing demands as there can be a large number of operations as well as a large amount of data to read and write.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a neural network implementing a selective state space model, according to some embodiments of the disclosure.

FIG. 2 illustrates a computing system having a neural network accelerator, according to some embodiments of the disclosure.

FIG. 3 illustrates sequential processing of a cumulative sum operation on a digital signal processor.

FIG. 4 illustrates data-parallel processing of the cumulative sum operation through matrix-to-matrix multiplication, according to some embodiments of the disclosure.

FIG. 5 depicts sparsity compression of a mask tensor, according to some embodiments of the disclosure.

FIG. 6 illustrates sequential processing of a reduce sum operation on a digital signal processor.

FIG. 7 illustrates data-parallel processing of the reduce sum operation through matrix-to-vector multiplication, according to some embodiments of the disclosure.

FIG. 8 illustrates efficient mapping of operations onto a data processing pipeline of a neural network accelerator, according to some embodiments of the disclosure.

FIG. 9 illustrates efficient mapping of operations onto a data processing pipeline of a neural network accelerator, according to some embodiments of the disclosure.

FIG. 10 illustrates methodology for improving execution performance of state space models on neural network accelerators, according to some embodiments of the disclosure.

FIG. 11 illustrates a DNN system, according to some embodiments of the disclosure.

FIG. 12 illustrates a processing engine, according to some embodiments of the disclosure.

FIG. 13 illustrates a sparse processing cell, according to some embodiments of the disclosure.

FIG. 14 illustrates sparse computation in the sparse processing cell, according to some embodiments of the disclosure.

FIG. 15 illustrates a post-processing engine, according to some embodiments of the disclosure.

FIG. 16 illustrates a DNN module, according to some embodiments of the disclosure.

FIG. 17 illustrates a compiler, according to some embodiments of the disclosure.

FIG. 18 depicts a flow diagram illustrating a method that can be carried out by a compiler, according to some embodiments of the disclosure.

FIG. 19 depicts a flow diagram illustrating a method that can be carried out by a neural network accelerator, according to some embodiments of the disclosure.

FIG. 20 is a block diagram of an exemplary computing device, according to some embodiments of the disclosure.

### DETAILED DESCRIPTION

### Overview

DNNs are widely used in the domains of computer vision, speech recognition, image, and video processing mainly due to their ability to achieve beyond human-level accuracy. A DNN typically includes a sequence of layers. A DNN layer may include one or more deep learning operations (also referred to as “neural network operations”), such as convolution, matrix multiplication, layer normalization, batch normalization, SoftMax operation, pooling, elementwise operation, linear operation, nonlinear operation, activation function, and so on.

DNN models may be executed, e.g., for training or inference, by neural network accelerators or neural network hardware accelerators implementing circuits that are designed to accelerate execution of neural network operations. Neural network accelerators can be referred to as neural processing units (NPUs), DNN accelerators, AI accelerators, etc. In some architectures, a DNN accelerator may be or include one or more data processing units (DPUs). A DPU may also be referred to as a compute block or compute tile. A DPU may include a processing engine (PE) that can carry out data-parallel neural network operations. A PE may include one or more multiply-and-accumulate (MAC) arrays. A DPU may also include a post-processing engine (PPE).

DNN accelerators are designed to accelerate execute deep learning workloads. They can be integrated into client personal computers (PCs) or other edge devices, DNN accelerators can be optimized for data-parallel computations like matrix multiplication, a fundamental operation in most neural networks. These accelerators can include DPUs equipped with MAC arrays to handle data-parallel neural network operations. To support some nonlinear activations and sequential, non-data-parallel operations, some DNN accelerators can include digital signal processors (DSPs) or vector DSPs to perform these computations.

State space models (SSMs) are a classical mathematical framework used to model dynamic systems through first-order differential equations. Adopted in fields like control systems, signal processing, and circuit design, SSMs have recently gained prominence in ML for their effectiveness in handling sequential data. SSM-based DNNs can excel in modeling long sequences efficiently, offering faster training and inference compared to transformers. Unlike transformers, which rely on attention mechanisms with quadratic computational complexity for key-value operations, SSMs can achieve linear or near-linear scalability with sequence length. SSMs can be computationally efficient and suitable for processing long sequences with reduced overhead. “Mamba”, a leading SSM-based model, can demonstrate modeling capabilities comparable to transformers while maintaining linear time complexity. Mamba incorporates a reparameterization mechanism to retain relevant information and discard irrelevant data efficiently, thus implementing a selective state space model. Building on Mamba, Mamba-2 introduces the structured state space duality (SSD) framework, connecting SSMs with attention mechanisms and enabling the reuse of optimization techniques initially developed for transformers. This evolution has made SSMs, such as Mamba and Mamba-2, promising candidates for replacing transformers in applications like natural language processing, computer vision, and medicine. Their efficient design and scalability make them an attractive backbone for modern sequence modeling tasks.

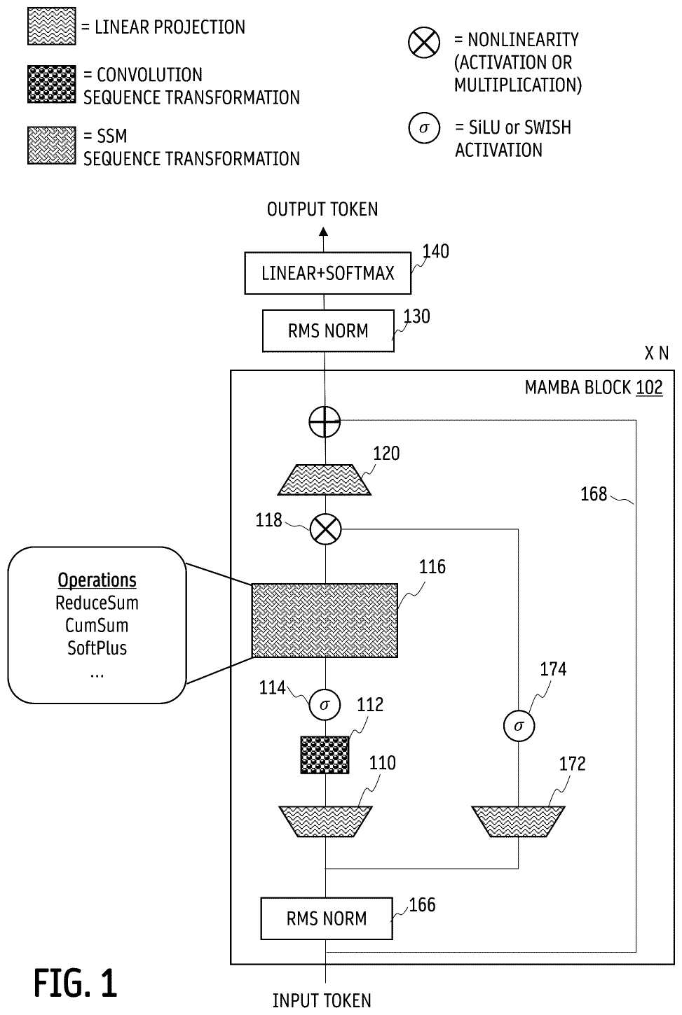

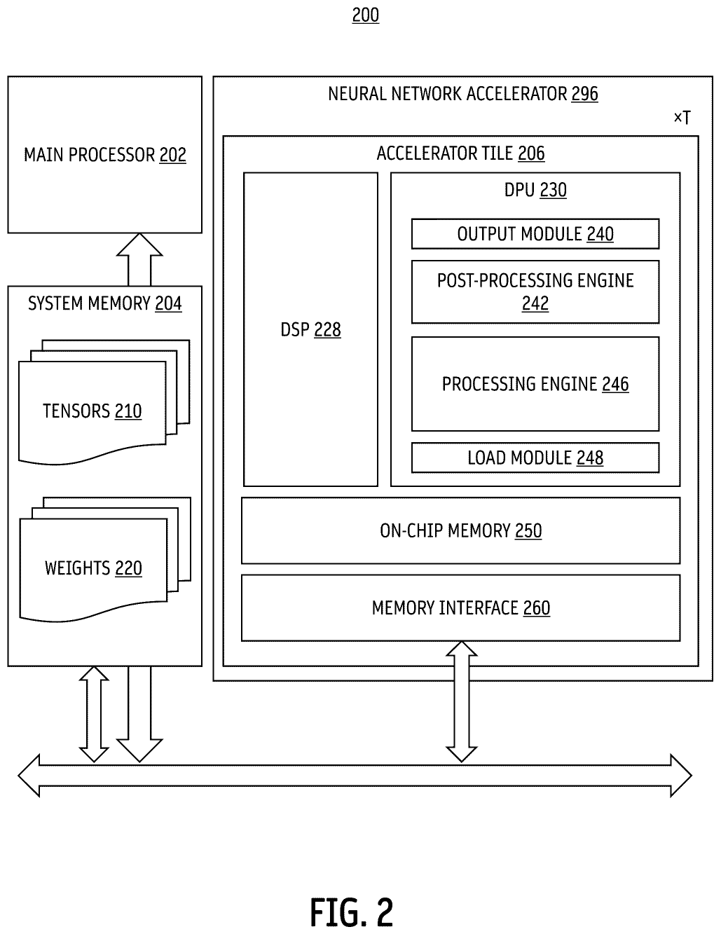

Deploying SSM-based DNNs on NPUs presents unique challenges due to their computational patterns and hardware requirements. Unlike other deep learning models such as transformers and convolutional neural networks (CNNs), SSMs exhibit characteristics that deviate from standard kernel operations, necessitating specialized optimizations. Many DNN accelerators are optimized for data-parallel operations like matrix multiplications, which dominate workloads in transformers and CNNs. SSMs, however, involve sequential computations and specialized operators, such as activation functions (e.g., Swish and SoftPlus), cumulative sum operation (referred to herein as CumSum operation) and reduce sum operation (referred to herein as ReduceSum operation). These operations do not align with the highly parallelized architecture of NPUs, leading to inefficient execution when mapped directly onto the DNN accelerator. In particular, these operations are mapped onto the DSP of the neural network accelerator for sequential processing. The inefficiencies are described in greater detail with FIGS. 1-2.

To address these inefficiencies, SSMs execution on DNN accelerators can be accelerated through better compilation of SSM-based DNNs, without having to change the existing hardware can be repurposed for advanced SSMs. The improved compiler can ensure faster integration, reduce deployment friction, and eliminate the need for new hardware designs, making it a practical step forward for adopting SSMs in edge computing devices equipped with DNN accelerators, taking full advantage of DNN accelerators' strengths.

### The Compiler

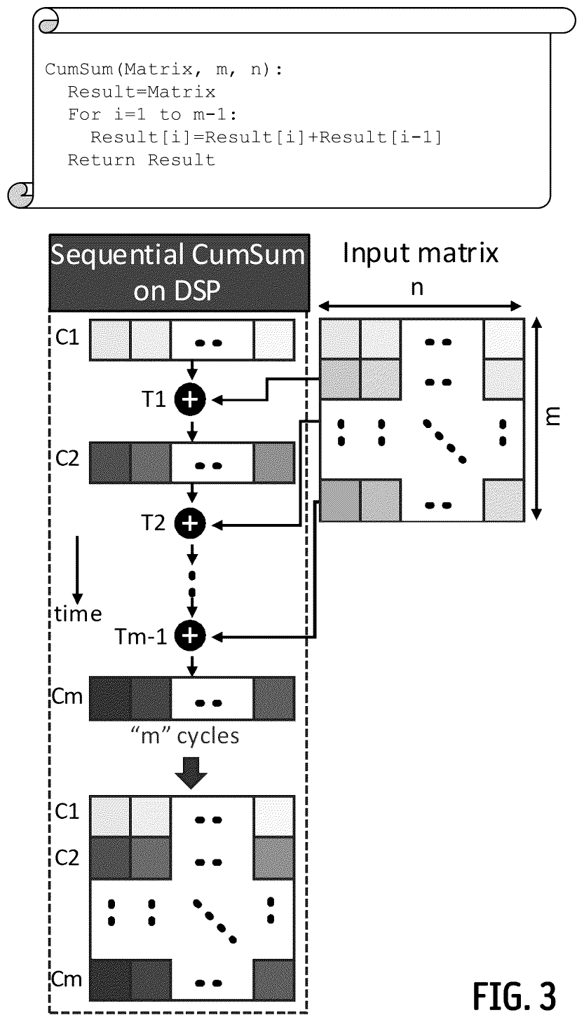

By leveraging the fast matrix multiplication capability of high-frequency data-parallel DPUs, the CumSum operation is mapped to a data-parallel matrix-to-matrix operation using a mask tensor (referred to as the CumSum mask) precomputed during compile time. The data-parallel operation is referred to herein as CumBA. This approach can solve the challenge of long execution time caused by sequential CumSum operations on DNN accelerators. The CumSum operation and CumBA optimization are described in greater detail in FIGS. 3-5.

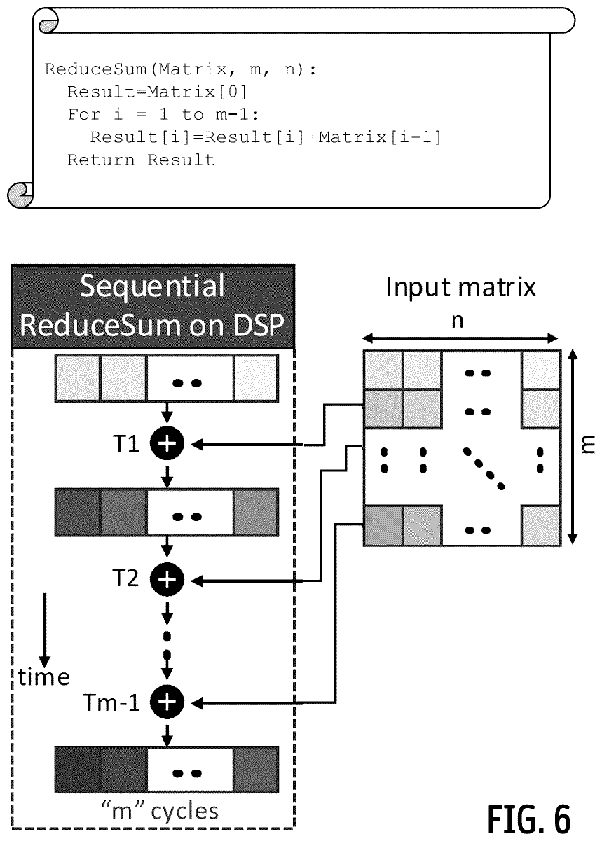

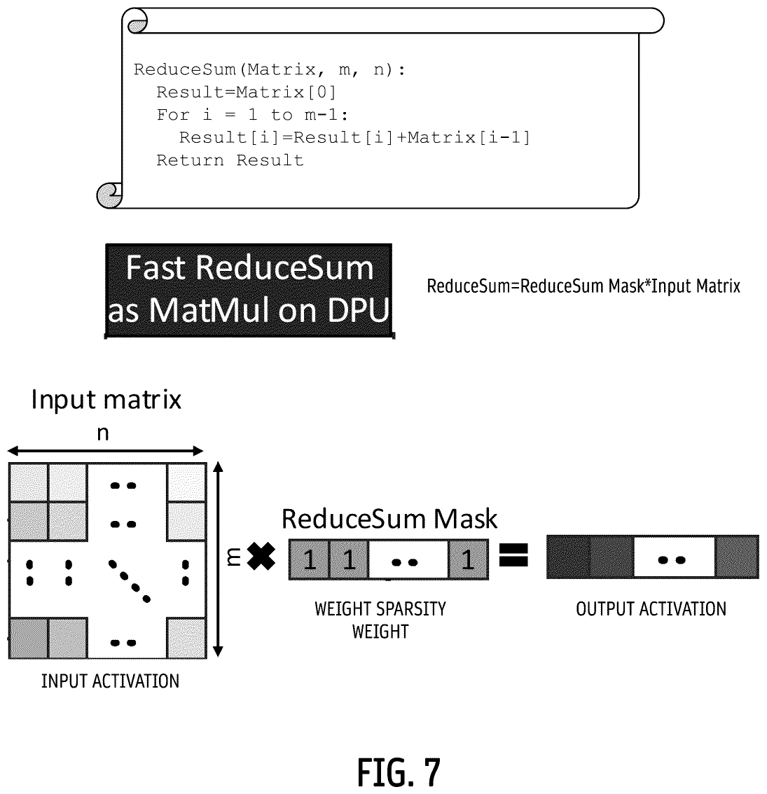

In addition, the ReduceSum operation is mapped to a data-parallel matrix-to-vector operation using a vector mask tensor (referred to as the ReduceSum mask) precomputed during compile time. The data-parallel operation is referred to herein as ReduBA. This approach can solve the challenge of long execution time caused by sequential ReduceSum operations on DNN accelerators. By utilizing the high-frequency, data-parallel processing capabilities of DPUs, ReduBA can reduce the end-to-end inference latency. The ReduceSum operation and ReduBa optimization are described in greater detail in FIGS. 6-7.

Herein, an aggregation operation encompasses the CumSum operation, the ReduceSum operation, and operations that perform tensor dimension reduction and accumulation operations.

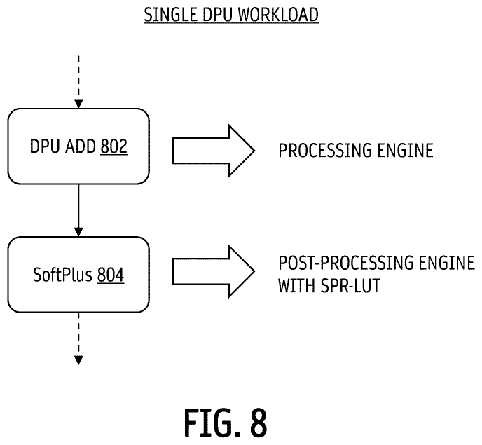

Moreover, by strategically utilizing the PPE in a drain path of a DPU of a neural network accelerator following a processing engine, computationally expensive activation functions, such as Swish activation function, Sigmoid Linear Unit (SiLU) activation function, and SoftPlus activation function, can be mapped onto a software programmable look-up table (Spr-LUT) in the PPE so that the activation function can be applied directly on the previous operation's output produced by the processing engine. This approach, referred to herein as ActiBA, can address the challenge of sequential execution bottlenecks and memory access bottlenecks on DNN accelerators, effectively reducing latency of SSM-based model execution. The ActiBA optimization is described in greater detail in FIGS. 8-9 and 15.

In addition to accelerating computation, various techniques described herein can address the memory-bounded nature of SSM-based DNN execution by reducing memory accesses and increasing data reuse, thereby enhancing effective memory bandwidth. CumBA can improve data reuse by mapping the CumSum operation to the DPU, which executes operations using data stored in local register files (which increase input and output data reuse) and eliminate redundant memory reads/writes to system memory associated with DSP-based execution. ReduBA, utilizing matrix-to-vector multiplication, can reuse the ReduceSum mask across multiple operations, significantly lowering memory traffic and further increasing memory bandwidth. ActiBA, performed during the drain phase of the previous layer, can avoid storing and reloading intermediate outputs from memory, effectively reducing memory access overhead.

Leveraging the sparsity in the CumSum mask in CumBA, which is a lower-triangular binary matrix with ˜50% zeros, a DNN accelerator that can perform sparse computations can further benefit from memory and compute optimization. By applying Zero Value Compression (ZVC), the storage and data transfer demands for the CumSum mask are significantly reduced. Additionally, by utilizing the DNN accelerator's support for compute skipping through sparsity bitmaps, unnecessary computations for zero values are avoided, resulting in accelerated execution and reduced memory traffic. This approach can enhance overall efficiency by minimizing storage usage and maximizing computational throughput.

By implementing one or more of CumBA, ReduBA, and ActiBA, SSM-based DNN execution performance on DNN accelerators can be significantly improved. CumBA can result in a 1.8X reduction in execution latency, ReduBA can achieve a 1.1X improvement, and ActiBA can deliver up to 2.6X reduction in execution latency compared to the initial out-of-the-box mapping.

### Understanding bottlenecks of SSM-based DNN models

FIG. 1 illustrates a neural network implementing a selective state space model, such as the Mamba model, according to some embodiments of the disclosure. The neural network may include N instances of Mamba block 102. Mamba block 102 represents one of the building blocks of the Mamba model.

Mamba block 102 may receive an input token of an input sequence comprising a plurality of input tokens. Mamba block 102 may first normalize the input token using root-mean-squared (RMS) normalization 166 to stabilize training. Skip connection 168 bypasses RMS normalization 166, enabling residual learning. The normalized input undergoes transformations through projection layer 110 and convolutional layer 112, followed by SiLU activation function 114 to introduce non-linearity. At the core of Mamba block 102 is selective SSM block 116, which operates on sequences using state equations. The state equation hₖ=Ahₖ₋₁+Bxₖ updates the hidden state hₖ by modeling temporal dependencies through the matrix A and incorporating new input xₖ via matrix B. The output equation yₖ=Chₖ maps the hidden state hₖ to the output yₖ using the matrix C, with optional augmentation by a learnable matrix D. The output from the selective SSM block 116 is combined with the original input (e.g., the normalized input passing through projection layer 172 and SiLU activation function 174) using elementwise operations in operator 118, such as elementwise addition or elementwise multiplication, followed by projection layer 120. The output of projection layer 120 is combined with the input passed through via skip connection 168 to form the output of Mamba block 102. The output of Mamba block 102 passes through RMS normalization 130 and a task-specific block 140 (e.g., involving a linear layer and a SoftMax function) to generate predictions, such as an output token. Mamba block 102 can be repeated M times in the overall SSM-based neural network model, forming a modular and scalable architecture for efficient sequence modeling.

When compiled for execution on a DNN accelerator, Mamba-based neural network models implementing Mamba block 102 as illustrated in FIG. 1 has one or more bottlenecks. Execution of the Mamba-based neural network model can be dominated by sequential DSP execution of Swish (SiLU) and SoftPlus, and sequential DSP execution of CumSum and ReduceSum operations. For Mamba-based neural networks, the majority of execution time can be consumed by activation functions, such as Swish, SiLU, and SoftPlus, which are executed sequentially on DSPs. These DSPs are less optimized for such operations, resulting in prolonged execution times and underutilization of the data-parallel units. In some Mamba-based neural networks, CumSum and ReduceSum emerge as primary bottlenecks, as these operations also rely on DSPs for sequential processing. This sequential nature hinders efficient reuse of on-chip memory, increasing memory traffic and access latency. Mamba-based neural networks further face challenges with elementwise multiplication (Multiply), which similarly runs on DSPs and contributes to inefficiencies. Handling long sequences in SSMs demands careful memory optimization because it is a challenge to effectively utilize on-chip memory and avoid frequent off-chip memory accesses, which can incur significant latency and energy costs. The lack of optimized dataflow alignment for SSM computations exacerbates this issue, leading to poor performance. Blind, out-of-the-box mapping of SSMs on DNN accelerators can result in suboptimal performance, leaving much of their potential benefits untapped. Overcoming these challenges can allow for SSM benefits to be fully leveraged in resource-limited settings. The challenges in mapping SSM-based DNNs onto DNN accelerators, such as mismatched kernel optimizations, sequential computation bottlenecks, and memory inefficiencies, hinder deployment of SSM-based DNNs onto commercial off-the-shelf (COTS) DNN accelerators. While specialized accelerators have been proposed for emerging neural networks, designing new hardware is time-intensive, costly, and impractical for every model. Instead, optimizing general-purpose DNN accelerators to handle diverse workloads offers a scalable and efficient solution.

FIG. 2 illustrates computing system 200 having neural network accelerator 296, according to some embodiments of the disclosure. Computing system 200 can further include main processor 202 and system memory 204. Computing system 200 may implement an application that may involve using neural network accelerator 296 to accelerate neural network operations or perform inferencing using a neural network. System memory 204 may store input and output tensors 210 of the neural network. System memory 204 may store parameters, such as weights 220, of the neural network.

Neural network accelerator 296 may include T instances of accelerator tile 206. Accelerator tile 206 may include on-chip memory 250 to store data such as tensors 210 and/or weights 220. Memory interface 260 may facilitate writing data from system memory 204 onto on-chip memory 250 and writing data back to system memory 204 from on-chip memory 250.

Accelerator tile 206 can include one or more instances of DSP 228. DSP 228 includes a Streaming Hybrid Architecture Vector Engine (SHAVE) DSP to handle neural network operations that are not mapped onto DPU 230. DSP 228 complements DPU 230 by handling specialized operations such as arithmetic, activation functions, data type conversions, or certain operations for limited data types.

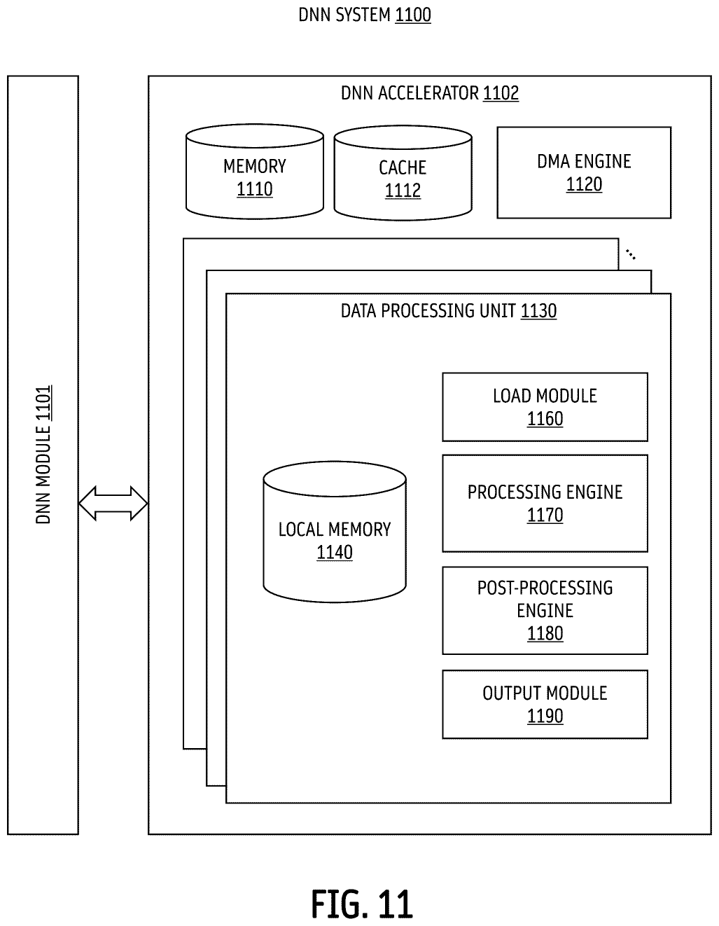

Accelerator tile 206 can include one or more instances of DPU 230. DPU 230 may include a data processing pipeline involving load module 248, processing engine 246, post-processing engine 242, and output module 240. Processing engine 246 can include a processing element array, or a sparse cell array. A sparse cell array can include a grid of sparse cells, where a sparse cell can have a MAC array having MAC processing elements that perform MAC operations. A MAC processing element may perform a multiply operation and an accumulation operation using a local data path having register files for multipliers and multiplicands, a multiplier to perform multiplication, and an accumulator to perform accumulation. Accordingly, processing engine 246 is optimized for high-throughput data-parallel matrix operations and MAC operations. Load module 248 can load data from on-chip memory 250 to processing engine 246. Output data from processing engine 246 is drained to post-processing engine 242. Output data of engine 242 can be drained by output module 240 and be written to on-chip memory 250. Additional details about DPU 230 are further described with FIGS. 11-15.

### Tensors

Input or output data of deep learning operations may be arranged in data structures called tensors. A tensor is a data structure having multiple elements across one or more dimensions. Examples of tensors include vector (which is one-dimensional (1D) tensor), matrix (which is two-dimensional (2D) tensor), three-dimensional (3D) tensors, four-dimensional (4D) tensors, and even higher-dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. Taking a convolutional layer for example, the input tensors include an activation tensor (also referred to as “input feature map (IFM)” or “input activation tensor”) including one or more activations (also referred to as “input elements”) and a weight tensor. The weight tensor may be a kernel (a 2D weight tensor), a filter (a 3D weight tensor), or a group of filters (a 4D weight tensor). A convolution may be performed on the input activation tensor and weight tensor to compute an output activation tensor in the convolutional layer.

Tensors in DNNs can be saved in X-major (e.g., XYZ or XZY format), Y-major formats (e.g., YXZ or YZX format), or Z-major formats (e.g., ZXY or ZYX format). The format of a tensor may define the order in which the data points in the tensor are stored, written, or read. The first character may represent the dimension in which data points are contiguous in memory. The second character may represent the dimension in which data points can be accessed after the contiguous data points are accessed in memory. The third character may represent the dimension in which data points are accessed after the data points in the dimension represented by the second character are exhausted. Taking the ZXY format for example, the access order first starts in the Z dimension, then moves to the X dimension, and finally moves to the Y dimension. Data points in the tensor are contiguous in memory in the Z dimension, meaning data points having the same (x, y) coordinates are contiguous in memory. Using tensor permutation, the tensor may be read from memory in a different format.

### Mapping CumSum to CumBA

One of the bottlenecks in executing SSM-based neural networks is the execution of cumulative sum (CumSum) operation, which suffers from high latency due to its sequential execution on the DSP.

FIG. 3 illustrates sequential processing of a cumulative sum operation on a digital signal processor. The CumSum operation computes the cumulative sum of elements along a specified dimension (or axis) of a tensor. The CumSum operation includes a cumulative sum operation along a dimension of the tensor. For a 2D tensor of shape m×m, CumSum along the rows (m-axis, or the dimension along m) means that each element in a column is replaced by the sum of all elements above it, including the element itself. This CumSum operation is naturally sequential, as each output element depends on the previous one. Because of this, compilers would map the CumSum operation onto the DSP for execution. Given that the DSP is equipped with an n-width vector adder, the output for each column can be computed sequentially over m cycles. For higher-dimensional tensors, the CumSum operation may be broken down into smaller chunks and processed sequentially by the DSP, further exacerbating the latency. This approach can also cause a significant increase in memory traffic and inefficient data reuse, particularly for tensors whose dimensions exceed the on-chip memory capacity, as intermediate results are written back and forth to off-chip memory.

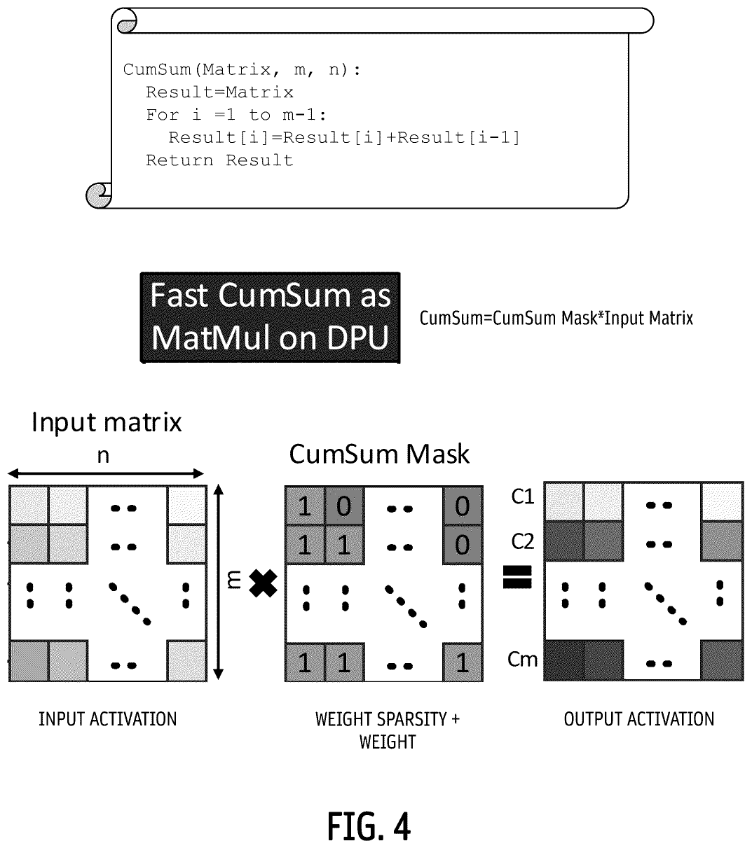

To overcome these inefficiencies, CumBA, a compiler-level optimization technique that remaps the CumSum operation to a matrix-to-matrix multiplication is introduced. FIG. 4 illustrates data-parallel processing of the cumulative sum operation through matrix-to-matrix multiplication, according to some embodiments of the disclosure. Instead of performing sequential adding operations, CumBA achieves the equivalent CumSum operation by pre-computing a binary mask tensor during compile time, shown as CumSum mask. The CumSum mask can be a lower-triangular binary matrix comprising ones on and below a diagonal and zeros above the diagonal. Optionally, the input tensor to the CumSum operation can be reshaped to align with the CumSum mask for matrix-to-matrix multiplication and accumulation along the particular dimension. The DPU can utilize the MAC array to execute a matrix-to-matrix multiplication of the input tensor and the mask tensor (CumSum mask) to obtain the output tensor (represented as CumSum=CumSum Mask*Input Matrix).

In some embodiments, the input tensor can be provided to the DPU as input activation, the mask tensor (CumSum mask) can be provided to the DPU as weights. DPU performs matrix-to-matrix multiplication of the input activation and the weights. The output activation of the DPU generated by performing the matrix-to-matrix multiplication represents the result of the CumSum operation on the input tensor.

As discussed in FIG. 2, the DPU has an array of high-frequency MAC processing elements, which are designed to handle matrix operations with significantly greater parallelism and efficiency compared to the sequential DSP. Utilizing the data-parallel processing capabilities of the DPU, the CumBA precomputes the CumSum mask during compile time with a shifting and/or saturating pattern of ones tailored to the CumSum operation. This CumSum mask can enable the transformation of CumSum into a matrix-to-matrix multiplication by reshaping the input tensor as needed.

This remapping of CumBA can ensure the computation is performed in parallel, leveraging the DPU's ability to execute many data-parallel operations simultaneously. Additionally, CumBA can improve data reuse through DPU-based stencils and eliminate redundant memory reads and writes to on-chip memory, addressing the inefficiencies of DSP-based execution. In some embodiments, the DPU can process matrix-to-matrix multiplication in a tiled manner, further enhancing data reuse within local register files and minimizing costly on-chip memory accesses. The result is an accurate and mathematically equivalent output with significantly reduced execution latency. By tackling both computational and memory inefficiencies of sequential CumSum, CumBA can achieve substantial improvements in performance and resource utilization on NPUs.

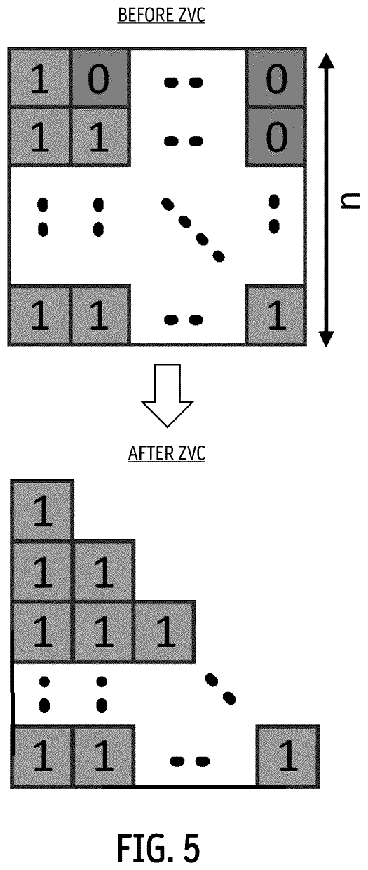

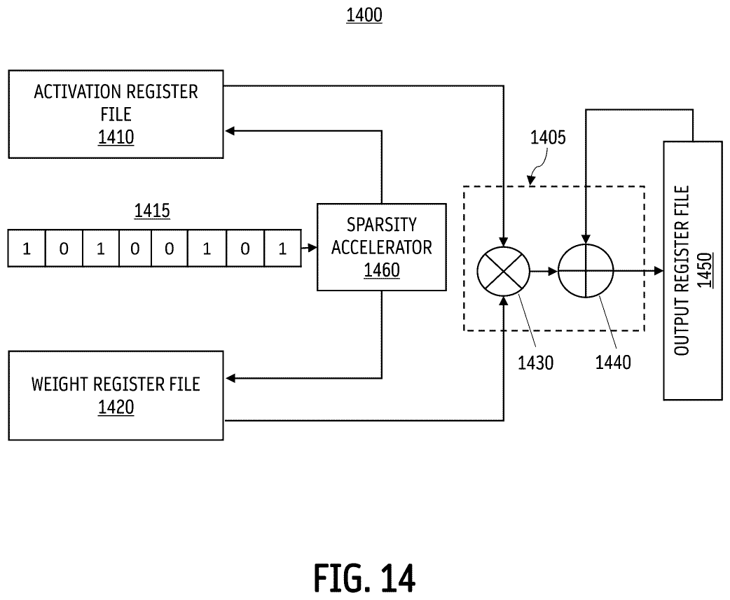

The ˜50% zeros in the CumSum mask in CumBA, represented as a lower-triangular binary matrix, can present an opportunity for further significant memory and compute optimizations. FIG. 5 depicts sparsity compression of a mask tensor, e.g., the CumSum mask, according to some embodiments of the disclosure. Memory storage, bandwidth, and compute efficiency can be achieved by exploiting the sparsity of the CumSum mask and utilizing sparsity acceleration logic in the processing engine. The sparsity acceleration logic is illustrated in FIG. 14. As shown in FIG. 5, all elements above the triangular are zero, making the mask highly sparse. By employing ZVC, the storage requirements for the mask can be greatly reduced, as the non-zero-valued elements are stored while the storage of the zero-valued elements can be avoided. This compression can also minimize memory traffic by reducing the volume of data transferred between memory and processing units. Furthermore, taking advantage of the sparsity compute support in the DNN accelerator, compute operations (e.g., the multiply operation and the accumulation operation) can be skipped using sparsity bitmaps. Utilizing the CumSum mask on a DNN accelerator with sparsity compute support thus can enable additional acceleration by bypassing computations for zero values.

In some embodiments, CumBA can leverage tiled processing supported by the DPU to efficiently execute the CumBA using multiple parallel tiles. Tile processing involves breaking large tensors into smaller, memory-friendly tiles that can be processed in parallel. When the input tensor is large, directly applying CumBA can overwhelm the limited on-chip memory resources. Tiled processing can divide the input tensor and the corresponding mask tensor into tiles—smaller submatrices that fit within the local memory and register files of the DPU. Each tile is processed independently using the same matrix multiplication logic, allowing the DPU to reuse data locally and avoid frequent off-chip memory accesses. This not only reduces memory traffic but also improves computational throughput by enabling parallel execution across multiple MAC arrays. After all tiles are processed, their outputs are stitched together to reconstruct the final CumBA result, preserving the semantics of the original CumSum operation. By combining parallelism with memory-efficient tiling, CumBA significantly reduces latency and enhances energy efficiency, making it ideal for deploying SSM-based DNNs on resource-constrained DNN accelerators.

### Mapping ReduceSum to ReduBA

Another one of the bottlenecks in executing SSM-based neural networks is the execution of reduce sum (ReduceSum) operation, which suffers from high latency due to its sequential execution on the DSP.

FIG. 6 illustrates sequential processing of a reduce sum operation on a digital signal processor. The ReduceSum operation computes the reduced sum of elements along a specified dimension (or axis) of a tensor. The ReduceSum operation includes a reduce sum operation along a dimension of the tensor. For an input tensor of shape m×n, a ReduceSum along the rows (m-axis or the dimension along m) produces an output tensor (vector) of length n, where each element in the output tensor represents the n, where each element represents the cumulative sum of the corresponding column. The ReduceSum operation reduces the dimensionality of the input tensor and performs accumulation operations of element in the column. The DSP, equipped with an n-width vector adder, produces the output over m cycles, as depicted in FIG. 8. For input tensors with higher dimensions, the ReduceSum operation is divided into smaller workloads, further increasing execution time. Additionally, for tensors with shapes exceeding the vector width of the DSP, multiple intermediate results are written to memory, leading to high memory traffic and inefficient on-chip memory utilization.

To address these limitations ReduBA, a compiler-level optimization technique that remaps the ReduceSum operation to a matrix-to-vector multiplication is introduced. FIG. 7 illustrates data-parallel processing of the reduce sum operation through matrix-to-vector multiplication, according to some embodiments of the disclosure.

Instead of performing sequential adding operations, ReduBa achieves the equivalent ReduceSum operation by pre-computing a binary mask tensor during compile time, shown as ReduceSum mask. The ReduceSum mask can be a vector mask comprising ones. Optionally, the input tensor to the ReduceSum operation can be reshaped to align with the ReduceSum mask for matrix-to-vector multiplication and accumulation along the particular dimension. The DPU can utilize the MAC array to execute a matrix-to-vector multiplication of the input tensor and the mask tensor (ReduceSum mask) to obtain the output tensor (represented as ReduceSum=ReduceSum Mask*Input Matrix).

In some embodiments, the input tensor can be provided to the DPU as input activation, the mask tensor (ReduceSum mask) can be provided to the DPU as weights. DPU performs matrix-to-vector multiplication of the input activation and the weights. The output activation of the DPU generated by performing the matrix-to-vector multiplication represents the result of the ReduceSum operation on the input tensor.

In ReduBA, a vector mask (ReduceSum mask) may be precomputed at compile time for the ReduceSum operation. The ReduceSum mask can capture the reduction pattern, allowing the ReduceSum operation to be reformulated as a matrix-to-vector multiplication. The input tensor may be reshaped, and the ReduBa may be then mapped to the DPU.

ReduBA can leverage the data-parallel architecture of the DPU to compute ReduceSum as a matrix-to-vector multiplication. The MAC arrays of the DPU can operate at a higher frequency and can support parallel computation more effectively than DSPs.

By leveraging matrix-to-vector multiplication, ReduBA can achieve superior data reuse. Specifically, the ReduceSum mask can be reused across many operations, significantly reducing memory traffic and effectively increasing the available memory bandwidth.

Additionally, ReduBA can utilize multiple MAC arrays within the DPU and employ a tiled computation strategy, further enhancing data reuse and minimizing on-chip memory accesses. Instead of processing the entire input tensor in one pass, the input tensor can be divided into smaller tiles that fit within the local memory and register files. Each tile is processed independently using matrix-to-vector multiplication with a precomputed ReduceSum mask, and partial results can be accumulated on-chip before writing the final output to memory.

These optimizations can collectively result in reduced latency and optimized memory usage for ReduceSum operations, significantly improving the execution efficiency of SSM-based DNN models on resource-constrained DNN accelerators.

### Mapping activation functions using ActiBA

As discussed with FIG. 1, some of the significant bottlenecks in Mamba's execution on DNN neural networks are the Swish or SiLU and SoftPlus activation functions. The activation functions are often scheduled to be executed by the DSP of the DNN accelerator, which can be slow. These activation functions are processed in a sequential loop on the DSP, where each assembly instruction exhibits varying execution times based on complexity. This sequential processing can result in high latency, contributing significantly to overall inefficiencies.

To address these bottlenecks, a pattern of operations, e.g., a data-parallel operation that can be performed by the processing engine (e.g., the multiply-and-accumulate array of the processing engine) followed by an activation function operation, can be identified in the connected neural network operations of the processing graph. Leveraging the data processing pipeline in the DPU, the pattern of operations can be performed in a single DPU workload, where the single DPU workload can configure the DPU to perform the data-parallel operation using the processing engine, apply the activation function operation directly onto the output data of the processing engine using a software programmable look-up table (Spr-LUT) in the post-processing engine. Leveraging the structure of the data path where the post-processing engine has a data signal path coupling the post-processing engine to the output of the processing engine, performing the pattern of operations in a single DPU workload can avoid excessive memory accesses when executing the pattern of operations. Compiled configuration descriptor overhead is also reduced when the pattern of operations can be performed with a single configuration workload descriptor instead of two configuration workload descriptors. The execution of the pattern of operations can be made more streamlined and faster through improved compilation.

DNN accelerators can include Spr-LUTs as part of the DPU, e.g., in the post-processing engine. Spr-LUTs are specialized hardware designed to approximate nonlinear activation functions. Unlike many approaches that compute these activations on a separate DSP, Spr-LUTs can offer a significant performance advantage by avoiding additional communication overhead and exploiting the higher clock frequencies of DPUs.

In ActiBA, the slopes and intercepts of the piecewise linear segments for activations such as Swish (SiLU) and SoftPlus may be precomputed and programmed into the look-up table within the Spr-LUT during compile time. At runtime, as the output of the preceding layer is drained from the processing engine of the DPU, the output may directly pass through the post-processing engine for additional processing. During this drain phase, the activation function operation may be performed in a fused and pipelined manner with the data-parallel operation of the preceding layer on the DPU, leveraging the precomputed slopes and intercepts stored in the Spr-LUT. This approach can eliminate the need to offload activation functions to the DSP, thereby avoiding the latency and inefficiencies associated with sequential DSP execution.

Furthermore, since ActiBA performs activation computations during the drain phase, it can eliminate the need to store the intermediate outputs of the preceding layer in memory and subsequently reload them for activation processing (also known as vertical fusion). This can significantly reduce memory access overhead, improve memory bandwidth utilization, and enhance overall dataflow efficiency. As these operations are usually simple linear computations integrated into the data drain process, the execution latency can be further minimized. By addressing both computational and memory inefficiencies, ActiBA can achieve a substantial reduction in end-to-end latency for Mamba-based models without compromising accuracy.

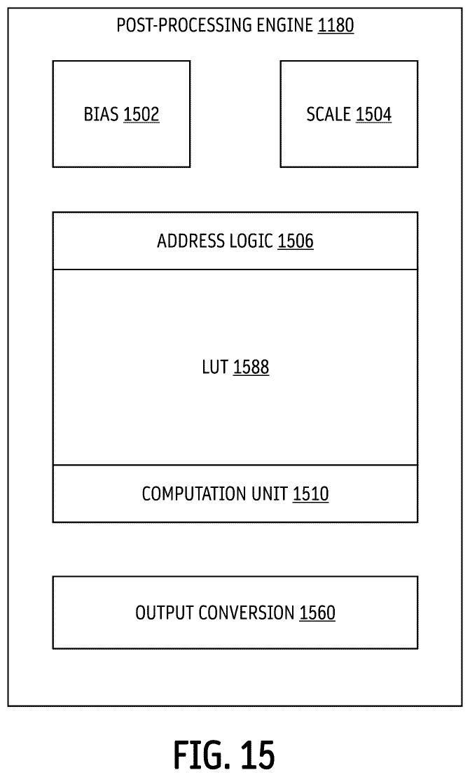

In some embodiments, a compiler can identify an operation and an activation function operation following the operation in the connected neural network operations of the processing graph. The operation can be mapped onto a DPU's processing engine. The activation function can be mapped onto the DPU's post-processing engine, leveraging the Spr-LUT. Exemplary implementation details of the post-processing engine are described with FIG. 15. The compiler can determine one or more machine-readable configurations for configuring the multiply-and-accumulate array of the neural network accelerator to perform the operation and a look-up table of a post-processing engine to store one or more slopes and one or more intercepts of one or more segments of the activation function. The unique data processing pipeline in the DPU includes the post-processing engine having a data signal path coupling the post-processing engine to the multiply-and-accumulate array to directly receive output data from the multiply-and-accumulate array and apply an operation onto the output data without having to access the output data from on-chip memory or off-chip memory.

FIG. 8 illustrates efficient mapping of operations onto a data processing pipeline of a neural network accelerator, according to some embodiments of the disclosure. Connected neural network operations in a data processing graph have DPU add 802 operation, followed by SoftPlus 804. The SoftPlus activation function being applied in SoftPlus 804 can be represented by:

$$SoftPlus ( x ) = \frac{1}{β} * log ( 1 + {e}^{β x} )$$

DPU add 802 can be performed using the multiply-and-accumulate array of the neural network accelerator, e.g., the processing engine of the DPU. SoftPlus 804 can be performed using the Spr-LUT of the post-processing engine.

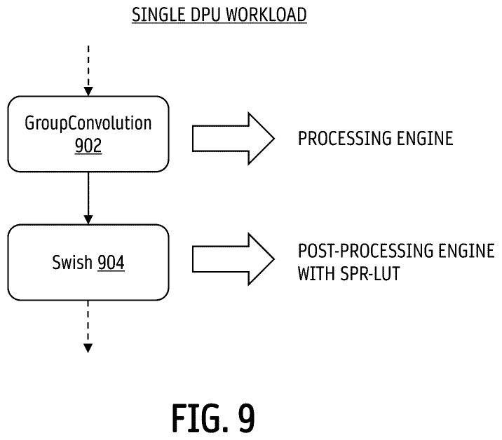

FIG. 9 illustrates efficient mapping of operations onto a data processing pipeline of a neural network accelerator, according to some embodiments of the disclosure. Connected neural network operations in a data processing graph have group convolution 902 operation, followed by Swish (SiLU) 904. The Swish (SiLU) activation function being applied in Swish (SiLU) 904 can be represented by:

$$S i L U ( x ) = x \cdot ( \frac{1}{1 + {e}^{- x}} )$$

Group convolution 902 can be performed using the multiply-and-accumulate array of the neural network accelerator, e.g., the processing engine of the DPU. Swish (SiLU) 904 can be performed using the Spr-LUT of the post-processing engine.

The post-processing engine can apply an activation function using piecewise linear approximations and leveraging Spr-LUTs for efficient computation. Swish and SoftPlus activation functions can exhibit linear behavior over most of their domain, except for regions near the origin. This property can enable their approximation using piecewise linear functions with minimal computational overhead. ActiBA can leverage piecewise linear approximation to compute these functions efficiently. ActiBA may use more linear segments near the origin (e.g., more look-up table entries near the origin), where the functions are highly nonlinear, and fewer segments farther from the origin (e.g., fewer look-up table entries farther from the origin), where they become nearly linear.

### End-to-end methodology for efficient execution of SSM-based DNNs

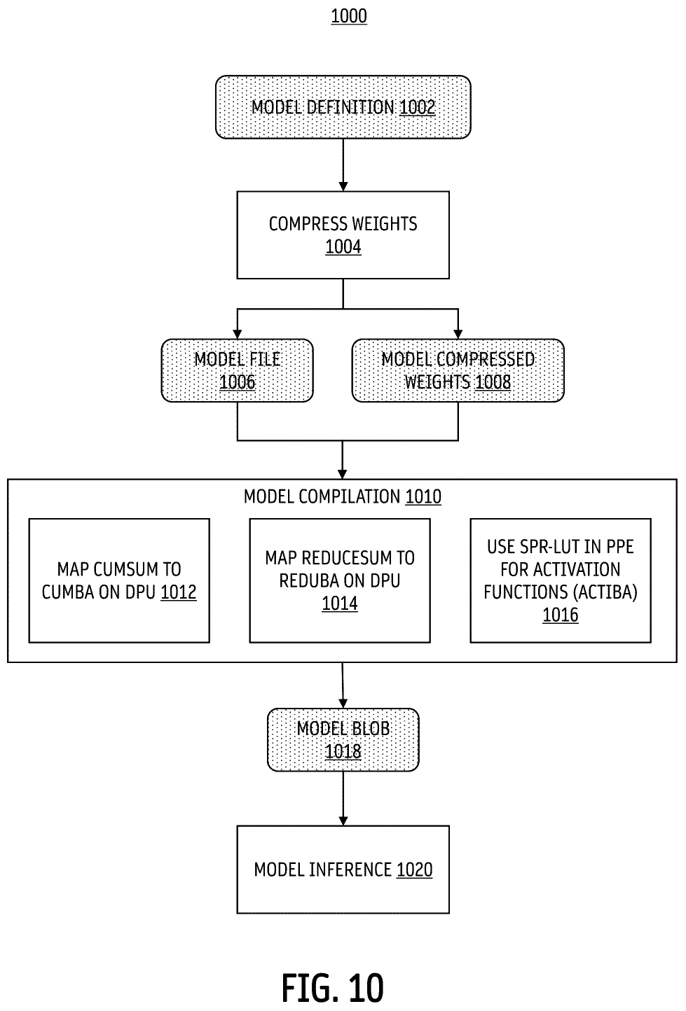

FIG. 10 illustrates methodology 1000 for improving execution performance of state space models on neural network accelerators, according to some embodiments of the disclosure. Methodology 1000 can be used to deploy DNNs, such as SSM-based DNNs, on a DNN accelerator to be executed efficiently, without retraining or hardware modifications. Methodology 1000 can ensure efficient execution while maintaining model performance by leveraging optimized software and compiler techniques. Methodology 1000 can maximize compatibility and performance, enabling the efficient execution of SSM-based DNNs on DNN accelerator hardware.

Model definition 1002 is received. Model definition 1002 may include information corresponding to a DNN, such as an SSM-based DNN. Model definition 1002 may include information corresponding to a pretrained DNN, such as a pretrained SSM-based DNN, or a pretrained Mamba-based model. Model definition 1002 includes information about the layers, such as the operations being performed and the connections of the layers of the DNN. Model definition 1002 includes parameters of the DNN.

In compress weights 1004, weights of the DNN in model definition 1002 can be compressed. A process implemented in compress weights 1004 can compress weights through quantization, which reduces the precision of model parameters from floating-point (e.g., 32-bit floating-point (FP32)) to lower-bit formats like 8-bit integer (INT8) or 16-bit floating-point (FP16), significantly reducing model size. In some cases, the process can also apply weight sharing and sparsity optimizations, where repeated values are stored once and zero weights are skipped. The inputs to this process are a model file (e.g., model definition 1002) and optional configuration parameters specifying the quantization scheme. The outputs are a revised model file 1006 (e.g., model.XML, an extensible markup language (XML) graph) and model compressed weights 1008 (e.g., model.bin, a binary file). This compression process implemented in compress weights 1004 can reduces storage and memory footprint while maintaining acceptable accuracy for inference.

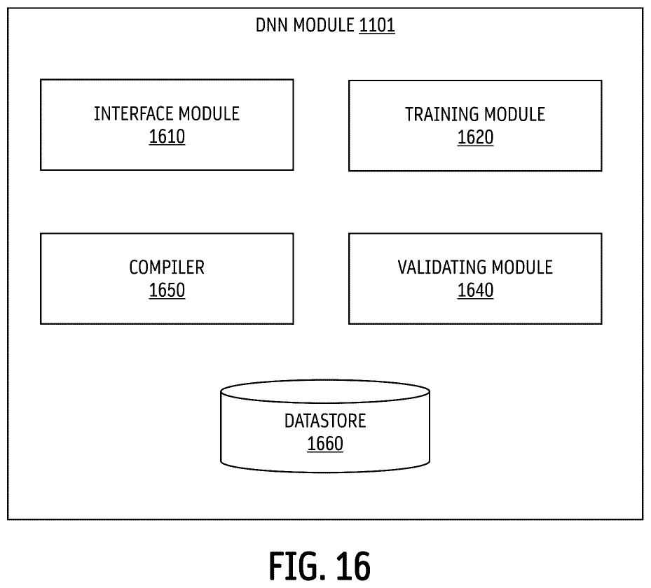

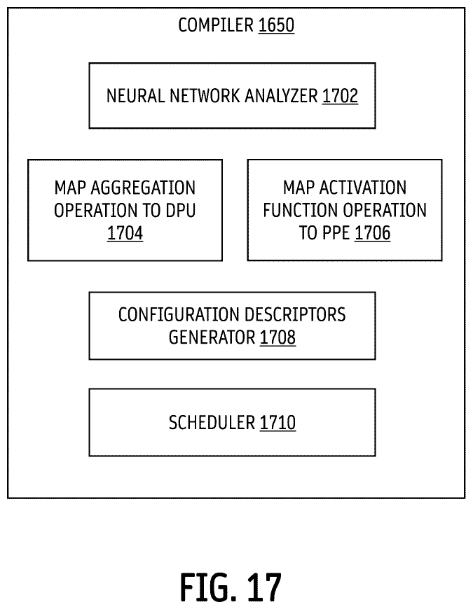

In model compilation 1010, the DNN is compiled. A compilation process implemented in model compilation 1010 can be carried out by a compiler (e.g., compiler 1650 of FIGS. 16 and 17). The compilation process can receive revised model file 1006 and model compressed weights 1008 and output model blob 1018. The compiler processes the processing graph having connected neural network operations. The compiler can analyze the processing graph and implement compiler optimizations. For example, the compiler can perform shape/type inference, and applies graph optimizations like constant folding, dead-code elimination, etc.

In some embodiments, the compilation process implemented in model compilation 1010 can include map CumSum to CumBA on DPU 1012. Map CumSum to CumBA on DPU 1012 maps the CumSum operation to CumBA to be executed on the DPU, as illustrated in FIG. 4. CumBA accelerates compute with matrix-to-matrix multiplication for CumSum and boosts memory bandwidth by improving data reuse and reducing redundant memory accesses.

In some embodiments, the compilation process implemented in model compilation 1010 can include map ReduceSum to ReduBA on DPU 1014. Map ReduceSum to ReduBA on DPU 1014 maps the ReduceSum operation to ReduBA to be executed on the DPU, as illustrated in FIG. 7. ReduBA enhances compute with matrix-to-vector multiplication for ReduceSum and reduces memory traffic by reusing the ReduceSum mask.

In some embodiments, the compilation process implemented in model compilation 1010 can include use Spr-LUT in post-processing engine for activation functions 1016 (referred to herein as ActiBA). Use Spr-LUT in post-processing engine for activation functions 1016 maps activation function operations to be executed using the look-up table in the post-processing engine, as illustrated in FIGS. 8-9. In some embodiments, a data-parallel operation and the activation function are mapped to a single DPU workload in a fused manner. ActiBA can speed up compute by offloading activation functions to specialized hardware and reduces memory overhead by avoiding intermediate output storage.

Model compilation 1010 includes one or more contributions, such as identifying and mapping aggregation operations (e.g., CumSum and ReduceSum operations) as matrix multiplications on the processing engine of the DPU during model compilation, and programming the Spr-LUT within the post-processing engine of the DPU to support activations such as Swish, SiLU, and SoftPlus activation functions.

The compiler performing model compilation 1010 can apply precision and layout transformations (such as FP32→FP16 or INT8 via low-precision transformations when available) and propagates optimal tensor layouts across the graph. Depending on the target processing device, the compiler performing model compilation 1010 can map operations in the processing graph to device-specific kernels, perform scheduling, and perform memory planning (buffer allocation/reuse and liveness analysis) to build an efficient execution pipeline. The output of compilation is a device-specific model blob 1018 or compiled, executable model, that can be used executed by the target processing device (e.g., a DNN accelerator) in model inference 1020.

The target processing device, equipped with output model blob 1018, can accept input tensors and produce output tensors in model inference 1020.

### Implementing DNNs on Processors or Neural Network Hardware Accelerators

The significant improvements in DNN model size and accuracy coupled with the rapid increase in computing power of execution platforms have led to the adoption of DNN applications even within resource-constrained mobile and edge devices that have limited power availability. DNN models may be executed, e.g., for training or inference, by DNN accelerators, or referred to herein as neural network hardware accelerators. A DNN accelerator may be or include one or more data processing units, or DPUs. A DPU may also be referred to as a compute block or compute tile. A DPU has highly specialized hardware circuitry to perform neural network operations. A DPU may include one or more processing engines that can carry out neural network operations or compute operations. A processing engine may include one or more processing cells to perform arithmetic operations associated with neural network operations, such as multiplication and multiplication and accumulate. A DPU may include one or more PPEs that can carry out neural network operations such as scaling, adding a bias, and applying an activation function.

Herein and as understood by one skilled in the art, a tensor is a mathematical object that includes scalars, vectors, and matrices, and even data structures in higher dimensions. At its most basic level, a tensor can be a single number, known as a scalar. When extended to one dimension, a tensor can be vector, which is an array of numbers. Further extending to two dimensions, a tensor can be a matrix, which is a grid of numbers. Beyond these, tensors can exist in multiple dimensions, representing complex data structures that can be manipulated and transformed in various ways by a DNN accelerator. In the context of neural networks, tensors can be used to store multi-dimensional data. A neural network involves operations on tensors. Examples of operations may include addition, subtraction, multiplication, convolution, reshaping, transposition, slicing and indexing, broadcasting, etc. The operations manipulate and transform tensors to perform neural network tasks such as training and inference.

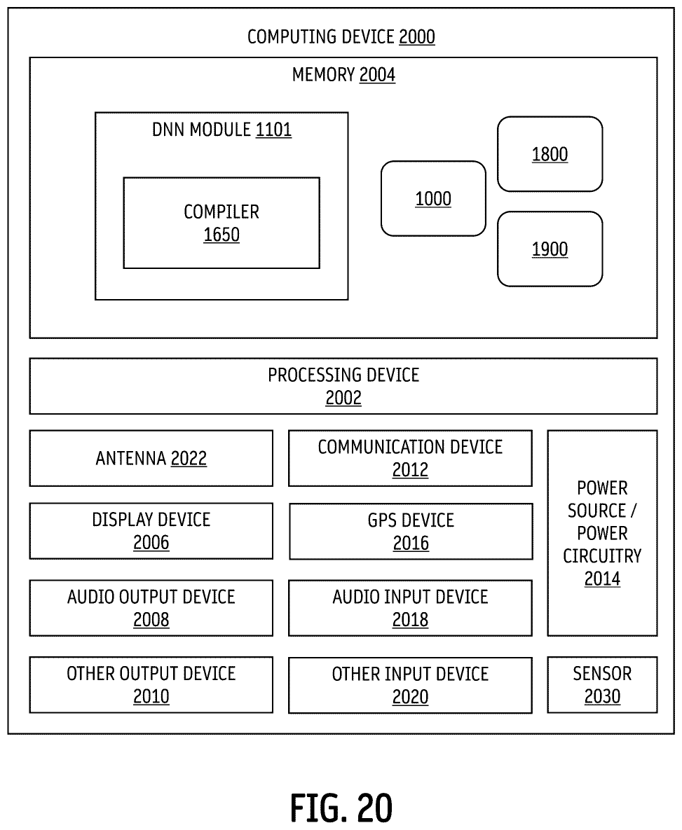

FIG. 11 illustrates DNN system 1100, according to some embodiments of the disclosure. The whole DNN system 1100 or a part of DNN system 1100 may be implemented in one or more computing devices, such as the computing device 2000 in FIG. 20. DNN system 1100 can generate and execute DNNs, such as transformer-based neural networks, CNNs, and so on. As shown in FIG. 11, DNN system 1100 includes DNN module 1101 and DNN accelerator 1102. In other embodiments, alternative configurations, different or additional components may be included in DNN system 1100. For instance, DNN system 1100 may include multiple DNN modules or multiple DNN accelerators. Further, functionality attributed to a component of DNN system 1100 may be accomplished by a different component included in DNN system 1100 or a different system. In some embodiments, DNN module 1101 and DNN accelerator 1102 may include or be implemented by different types of processing units. In an example, DNN module 1101 may be implemented by one or more central processing units (CPUs). DNN accelerator 1102 may also be referred to as a neural network hardware accelerator, a neural processing unit, AI accelerator, or AI processor. DNN module 1101 and DNN accelerator 1102 may be implemented in the same chip or as separate chips.

DNN module 1101 facilitates generation and deployment of DNNs. In some embodiments, the DNN module 1101 may generate and train DNNs. For instance, DNN module 1101 can define the layered architecture of a DNN. DNN module 1101 can also determine the internal parameters of the DNN through a DNN training process. DNN module 1101 may also determine one or more hyperparameters that define how the DNN is trained. An example hyperparameter is a sparsity ratio that defines the sparsity level of one or more deep learning tensors for the DNN.

DNN module 1101 may compress DNNs, e.g., during or after training. In some embodiments, DNN module 1101 may prune weights in one or more layers of a DNN by changing non-zero-valued weight to zeros. DNN module 1101 may prune weights based on a target weight sparsity ratio. A weight sparsity ratio may be the ratio of the number of zero-valued weights to the total number of weights. In an example where the DNN module 1101 prunes weight during DNN training, the DNN module 1101 may prune weight of a layer to achieve a target sparsity ratio after one or more epochs. DNN module 1101 may prevent the pruned weights from changing values during the rest of the training process. Alternatively, DNN module 1101 may allow the pruned weights to change values so that a pruned, zero-valued weight may have a non-zero value after further training. DNN module 1101 may prune weights of the layer again after one or more additional epochs.

DNN module 1101 may deploy trained, compressed, or validated DNNs for use in deep learning applications. In some embodiments, DNN module 1101 may distribute trained, compressed, or validated DNNs to devices or systems which may use the DNNs to perform tasks (e.g., image classification, motion planning, etc.) for which the DNNs were trained. In other embodiments, DNN module 1101 may facilitate deployment of the DNNs using the DNN accelerator 1102. For instance, DNN module 1101 may receive data from a device or system coupled with DNN system 1100 and input the received data (or data generated by DNN module 1101, e.g., based on the received data) into a DNN. In some embodiments, DNN module 1101 may control execution processes of trained, compressed, or validated DNNs.

DNN module 1101 may compile instructions executable by DNN accelerator 1102 to perform operations of a DNN in accordance with a model definition of the DNN. DNN module 1101 may generate instructions (e.g., configuration descriptors, low-level machine instructions, etc.) that control the operation of the DNN accelerator 1102 during the DNN execution. The instructions may correspond to one or more data processing workloads sent from DNN module 1101 to DNN accelerator 1102, where the one or more data processing workloads are to be executed by DNN accelerator 1102. DNN module 1101 may function as a compiler for DNNs to be deployed onto and executed by DNN accelerator 1102. DNN module 1101 may perform compilation of DNNs and generate configuration descriptors and/or low-level machine instructions, based on which the DNNs may be executed. The instructions may be used to configure or control processing cells of processing engine 1170 to perform one or more deep neural network operations. The instructions may be used to configure or control post-processing engine 1180 to perform one or more operations such as applying an activation function. Certain aspects of the DNN module 1101 are described and illustrated in FIG. 16.

DNN module 1101 may receive an output of the DNN from the DNN accelerator 1102. DNN module 1101 may transmit the output of the DNN (or a result of processing the output of the DNN by DNN module 1101) to the device or system.

DNN accelerator 1102 executes operations of DNNs, based on instructions (configuration descriptors and/or low-level machine instructions) provided by DNN module 1101. For instance, DNN accelerator 1102 can execute a DNN by running deep learning operations in the DNN. The process of carrying out a deep learning operation is also referred to as a process of executing the deep learning operation or a process of performing the deep learning operation. The execution of the DNN may be for training the DNN or for using the DNN to perform AI and/or inference tasks.

In some embodiments, DNN accelerator 1102 corresponds to neural network accelerator 296 of FIG. 2. In some embodiments, data processing unit 1130 corresponds to DPU 230.

As shown in FIG. 11, DNN accelerator 1102 includes memory 1110, direct memory access (DMA) engine 1120, and data processing units 1130 (individually referred to as “data processing unit 1130”). In other embodiments, alternative configurations, different or additional components may be included in DNN accelerator 1102. For example, DNN accelerator 1102 may include more than one memory 1110 or DMA engine 1120. As another example, DNN accelerator 1102 may include a single data processing unit 1130. Further, functionality attributed to a component of DNN accelerator 1102 may be accomplished by a different component included in DNN accelerator 1102 or by a different system. A component of DNN accelerator 1102 may be implemented in hardware, software, firmware, or some combination thereof.

Memory 1110 stores data associated with deep learning operations performed by DNN accelerator 1102. Example deep learning operations include convolutions (also referred to as “convolutional operations”), layer normalization operations, SoftMax operations, matrix multiplication operations, pooling operations, elementwise operations, activation functions, other types of deep learning operations, or some combination thereof.

In some embodiments, memory 1110 may store data to be used by the data processing units 1130 for DNN execution. memory 1110 may store weights, such as weights of convolutional layers, which are determined by training DNNs. Memory 1110 may further store inputs to DNN layers and/or outputs of DNN layers, such as data generated by the data processing units 1130 from performing deep learning operations in DNNs.

Memory 1110 may store instructions (e.g., configuration descriptors, low-level machine instructions, etc.) executable by DNN accelerator 1102, such as instructions executable by data processing unit 1130. Memory 1110 may be a main memory of DNN accelerator 1102. In some embodiments, memory 1110 includes one or more dynamic random access memories (DRAMs). In some embodiments, cache 1112 may serve as a cache for memory 1110. Cache 1112 may include one or more static random access memories (SRAMs). Cache 1112 may offer faster data/memory accesses than memory 1110. Cache 1112 may store data that is frequently accessed. Capacity of cache 1112 is smaller than the capacity of memory 1110.

DMA engine 1120 facilitates data transfer between memory 1110 and local memories 1140 of the data processing units 1130. For example, DMA engine 1120 can read data from memory 1110 and write data into local memory 1140 of data processing unit 1130. As another example, DMA engine 1120 can read data from local memory 1140 of data processing unit 1130 and write data into memory 1110. DMA engine 1120 provides a DMA feature that allows data processing unit 1130 to initiate data transfer between memory 1110 and local memories 1140 of the data processing units 1130 and to perform other operations while the data transfer is being conducted. In some embodiments, DMA engine 1120 may read tensors from memory 1110, modify the tensors in a way that is optimized for data processing unit 1130 before it writes the tensors into local memories 1140 of data processing units 1130.

Data processing units 1130 perform deep learning operations in DNNs. For instance, data processing unit 1130 may execute a DNN layer by running one or more deep learning operations in the DNN layer. Data processing unit 1130 may execute a layer, or a portion of a layer, at a time. In some embodiments, the operations of the DNN layers may be run by multiple data processing units 1130 in parallel. For instance, multiple data processing units 1130 may each perform a data processing workload, or a portion of a data processing workload for a deep learning operation. Data may be shared between data processing units 1130. Data processing unit 1130 may also be referred to as a compute block, or a compute tile.

Data processing units 1130 may be capable of running various types of deep learning operations, such as convolution, layer normalization, SoftMax operation, pooling, elementwise operation, linear operation, nonlinear operation, matrix multiplication (MatMul), and so on. Deep learning operations performed by the data processing units 1130 include tensor operations, i.e., operations whose inputs are tensors or operations whose outputs are tensors. In an example, data processing unit 1130 receives an input tensor and one or more convolutional kernels and performs a convolution with the input tensor and convolutional kernels. The result of the convolution may be an output tensor, which can be further computed, e.g., by data processing unit 1130 or another data processing unit 1130.

In the embodiments of FIG. 11, each data processing unit 1130 includes local memory 1140, load module 1160, processing engine 1170, post-processing engine 1180, and output module 1190. Data processing unit 1130 may include a data processing pipeline that includes load module 1160, processing engine 1170, post-processing engine 1180, and output module 1190. Some or all the components of the data processing unit 1130 can be implemented on the same chip. In other embodiments, alternative configurations, different or additional components may be included in the data processing unit 1130. Further, functionality attributed to a component of data processing unit 1130 may be accomplished by a different component included in the data processing unit 1130, a different data processing unit 1130, another component of the DNN accelerator 1102, or a different system. A component of the data processing unit 1130 may be implemented in hardware, software, firmware, or some combination thereof.

Local memory 1140 is local to the corresponding data processing unit 1130. In the embodiments of FIG. 11, local memory 1140 is inside the data processing unit 1130. In other embodiments, local memory 1140 may be outside the data processing unit 1130. Local memory 1140 may include one or more SRAMs. The capacity of local memory 1140 (e.g., 1.5-2 Megabytes) may be far smaller than the capacity of memory 1110. Data in local memory 1140 may be transferred to or from memory 1110, or cache 1112, e.g., through DMA engine 1120. In some embodiments, data in local memory 1140 may be transferred to or from local memory 1140 of another data processing unit 1130. Local memory 1140 may store data received, used, or generated by load module 1160, processing engine 1170, post-processing engine 1180, or output module 1190. Examples of the data may include input activations, weights, output activations, low-level machine instructions, configuration descriptors, and so on.

In some embodiments, local memory 1140 may store tensors to be processed by the processing engine 1170 or the post-processing engine 1180. The tensors may be input tensors of deep learning operations. Local memory 1140 may also store tensors generated by processing engine 1170 or post-processing engine 1180. The tensors may be output tensors of deep learning operations. The layout of data points of a tensor in local memory 1140 may depend on the format in which the tensor is stored. In some embodiments, local memory 1140 may store tensors in various formats, including Z-major format, X-major format, and Y-major format. For a tensor with Z-major format, the local memory 1140 may store data points having the same (x, y) coordinate contiguously. For instance, the data points having the same (x, y) coordinate may be stored at a sequence of memory addresses the local memory 1140. For a tensor with the ZXY format or ZYX format, local memory 1140 may store data points having the same (x, y) coordinate contiguously. For instance, the data points having the same (x, y) coordinate may be stored at a sequence of memory addresses in local memory 1140. For a tensor with X-major format, local memory 1140 may store data points having the same (y, z) coordinate contiguously. For a tensor with Y-major format, local memory 1140 may store data points having the same (x, z) coordinate contiguously.

In some embodiments, local memory 1140 may store dense tensors (e.g., dense activation tensors, dense weight tensors, etc.), sparse tensors (e.g., sparse activation tensors, sparse weight tensors, etc.), and so on. A dense tensor may be a tensor from which zero-valued elements (if any) are not removed. A dense tensor may be converted to a sparse tensor by removing one or more zero-valued elements in the dense tensor. A sparse tensor may also be referred to as a compressed tensor or packed tensor. The process of converting a dense tensor to a sparse tensor may be referred to as sparsity encoding. Sparsity encoding may also generate a sparsity tensor. Each element in the sparsity tensor may correspond to a different element in the dense tensor and indicate whether the element in the dense tensor is zero or not. The sparsity tensor may indicate positions of elements of the sparse tensor in the dense tensor. The sparsity tensor may include a sparsity bitmap, each element of which is a bit. A sparse tensor may be converted to a dense tensor through a densifying process, in which one or more zeros may be added to the sparse tensor based on the sparsity tensor.

In some embodiments, local memory 1140 includes one or more SRAMs. Local memory 1140 may be byte-addressable, and each memory address identifies a single byte (eight bits) of storage. In some embodiments, local memory 1140 may include memory banks. The number of data banks in the local memory 1140 may be 16, 64, 128, 356, 512, 1124, 1648, or other numbers. A memory bank may include a plurality of storage units. In an example, a data bank may include 8, 16, 64, or a different number of storage units. A memory bank or a storage unit in a memory bank may have a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from local memory 1140 in a single read cycle. In other embodiments, 16 bits can be transferred from local memory 1140 in multiple read cycles, such as two cycles.

Load module 1160 loads data from local memory 1140 to the processing engine 1170 or to post-processing engine 1180. Load module 1160 may load data from local memory 1140 to one or more data buffers of the processing engine 1170. Load module 1160 may read tensors from the local memory 1140. The tensors may include sparse activation tensors, sparse weight tensors, activation sparsity tensors, weight sparsity tensors, and so on. In some embodiments, load module 1160 may load data based on a sparsity mode. Load module 1160 may select different data to transmit to the processing engine 1170 in different sparsity modes.

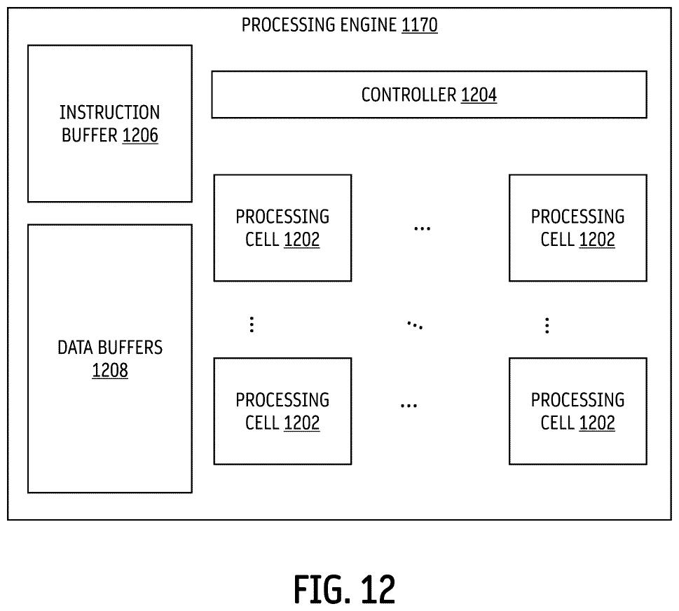

Processing engine 1170 performs neural network operations of DNNs. An exemplary processing engine 1170 is described and illustrated in FIG. 12.

Post-processing engine 1180 processes outputs of processing engine 1170. The post-processing engine 1180 may include one or more post-processing elements. In some embodiments, the post-processing elements in the post-processing engine 1180 may be arranged in an arrangement (e.g., in an array arrangement) that has rows and columns. In some embodiments, post-processing engine 1180 computes activation functions. Post-processing engine 1180 may receive outputs of processing engine 1170 as inputs to the activation functions. In addition or alternative to activation functions, post-processing engine 1180 may perform other types of post-processing on outputs of processing engine 1170. For instance, post-processing engine 1180 may apply a bias on an output of processing engine 1170. For instance, post-processing engine 1180 may perform scaling on an output of processing engine 1170. In some embodiments, post-processing engine 1180 may be bypassed for certain neural network operations.

Output module 1190 drains data from processing engine 1170 and/or from post-processing engine 1180. Output module 1190 may write the data to local memory 1140. The drained data may be tensors, such as output tensors of neural network operations. In some embodiments, output module 1190 may drain data on a cell level of processing engine 1170. For each processing cell, output module 1190 may drain outputs of processing elements in the processing cell based on a row index or column index of each processing element. For instance, output module 1190 may use a sequence of cycles to drain data from a processing cell. Output module 1190 may drain the output of some of the processing elements in each cycle. The sequence of the cycles may be configured based on a configuration parameter indicating the operation mode of load module 1160. The drained data, e.g., tensors, may be further loaded to memory 1110, e.g., through the DMA engine 1120. Additionally or alternatively, the drained data may be loaded by the load module 1160 to the processing engine 1170 for further computation, e.g., for performing a deep learning operation in the next layer.

FIG. 12 illustrates processing engine 1170, according to some embodiments of the disclosure. Processing engine 1170 may be included as part of a data processing unit, such as data processing unit 1130 of FIG. 11. Processing engine 1170 may include one or more processing cells 1202. In some embodiments, processing cells 1202 may be arranged in one or more rows and/or one or more columns in the processing engine 1170. In some embodiments, processing cells 1202 may be arranged as one or more sets or arrays of processing cells 1202 performing different operations. Processing engine 1170 may have one or more arrays of multiply-and-accumulate circuity (e.g., processing cells 1202) optimized to perform compute operations such as MatMul and convolution.

Each processing cell (e.g., processing cell 1202) may include one or more processing elements. In some cases, a processing cell includes a single processing element. In some cases, a processing cell includes a plurality of processing elements. The processing elements may be arranged as an array. The processing elements may be arranged in rows and/or columns. In some cases, a processing cell may include processing element(s) that perform the same operation. In some cases, a processing cell may include processing element(s) that perform different operations. In some cases, at least some of the processing element(s) in a processing cell may be arranged to perform operations in parallel. In some cases, at least some of the processing element(s) in a processing cell may be arranged to perform operations serially.

A processing element may perform an arithmetic operation associated with neural network operations or DNN operations. In some cases, the one or more processing elements that may be arranged in an array that includes rows and columns. Examples of processing elements may include a multiply unit, a division unit, a scaling unit, an adding unit, an accumulator unit a subtractor unit, a logarithmic unit, an exponentiation unit, a multiply-accumulate (MAC) unit, a bit shift unit, a square root unit, etc. The processing elements in processing cells may be arranged to perform an arithmetic operation on a vector of inputs to generate a vector of outputs (in parallel), sometimes referred to as vector processing. The processing elements in processing cells may perform scalar operations.

Processing engine 1170 may include controller 1204, which may configure circuitry of one or more processing cells 1202 to perform the arithmetic operations. In some cases, controller 1204 may configure one or more processing cells 1202 (or individual processing elements in a processing cell 1202) to perform operations in a particular sequence or manner. In some cases, controller 1204 may configure one or more processing cells 1202 (or individual processing elements in a processing cell 1202) according to instructions (e.g., configuration descriptors, and/or low-level machine instructions) loaded in instruction buffer 1206. Controller 1204 may include a program counter to determine the instructions loaded in instruction buffer 1206 to be executed by one or more processing cells 1202 (or individual processing elements in a processing cell 1202).

The instructions (e.g., configuration descriptors, and/or low-level machine instructions) loaded in instruction buffer 1206 may signal which processing cells 1202 (or individual processing elements in a processing cell 1202) is to execute or carry out one or more operations. Instruction buffer 1206 may include one or more register files, or one or more arrays of memory cells.

Data may be loaded in data buffers 1208 by controller 1204 and/or load module 1160 of FIG. 11. The data may be used by processing cells 1202. Data produced by processing cells 1202 may be drained from data buffers 1208 by output module 1190 to local memory 1140 of FIG. 11. Data buffers 1208 may include one or more register files, or one or more arrays of memory cells.

Data buffers 1208 may include one or more of: one or more input data buffers, and one or more output data buffers. Data buffers 1208 may include one or more weights/parameters buffers. Data buffers 1208 may store operands for one or more processing elements of processing cell 1202. Data buffers 1208 may store generated outputs of one or more processing elements of processing cell 1202.

The instructions (e.g., configuration descriptors, and/or low-level machine instructions) loaded in instruction buffer 1206 may signal which data stored in data buffers 1208 is to be processed by processing cells 1202 (or individual processing elements in a processing cell 1202). In some cases, the processing cells 1202 (or individual processing elements in a processing cell 1202) may read data from data buffers 1208 at a default location for the processing cell 1202 or an individual processing element in the processing cell 1202.

The instructions (e.g., configuration descriptors, and/or low-level machine instructions) loaded in instruction buffer 1206 may signal where to store output data in data buffers 1208 after processing cells 1202 produces the output data. In some cases, the processing cells 1202 (or individual processing elements in a processing cell 1202) may write data to data buffers 1208 at a default location for the processing cell 1202 or an individual processing element in the processing cell 1202.

Load module 1160 of FIG. 11 may load data to certain locations in data buffers 1208. Output module 1190 of FIG. 11 may drain data from data buffers 1208 to be stored in local memory 1140 and/or memory 1110 of FIG. 11.

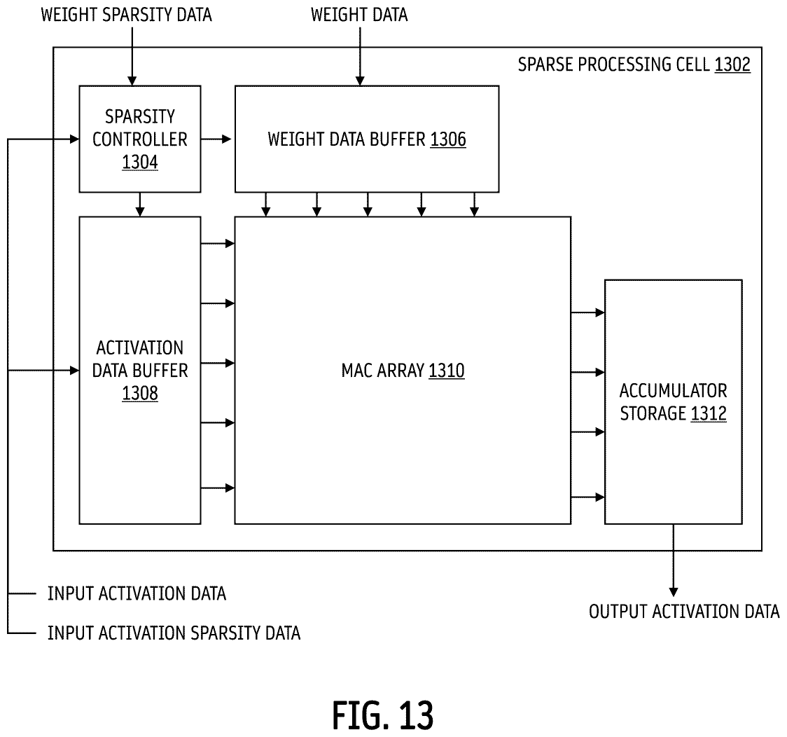

FIG. 13 illustrates sparse processing cell 1302 according to some embodiments of the disclosure. Sparse processing cell 1302 illustrates an exemplary implementation of processing cell 1202. In some embodiments, processing engine 1170 may include sparsity acceleration logic for facilitating and supporting sparsity acceleration. For instance, each processing cell 1202 in the processing engine 1170 may implement components of sparse processing cell 1302.

Sparse processing cell 1302 may include sparsity controller 1304, and MAC array 1310. Sparse processing cell 1302 may include weight data buffer 1306 to store weight data, and activation data buffer 1308 to store input activation data. Sparse processing cell 1302 may include accumulator storage 1312 to store accumulated data and produce output activation data. Sparsity controller 1304 may receive one or more of: weight sparsity data and input activation sparsity data.

In some embodiments, sparsity controller 1304 accelerates computations in MAC array 1310 based on sparsity in activations, sparsity in weights, or both to offer two-sided sparsity acceleration. Sparsity controller 1304 may include a storage unit that stores a sparsity tensor, which may be loaded to the storage unit by the load module 1160 of FIG. 11. The sparsity tensor may be an activation sparsity tensor, a weight sparsity tensor, or a combined sparsity tensor.

An activation sparsity tensor may be the sparsity tensor of an activation tensor and has the same number of elements as the activation tensor. An element in the activation sparsity tensor may indicate whether the corresponding element in the activation tensor is zero or not. For instance, a zero-valued in the activation sparsity tensor may indicate that the corresponding element in the activation tensor is zero. A one-valued in the activation sparsity tensor may indicate that the corresponding element in the activation tensor is non-zero.

A weight sparsity tensor may be the sparsity tensor of a weight tensor and has the same number of elements as the weight tensor. An element in the weight sparsity tensor may indicate whether the corresponding element in the weight tensor is zero or not. For instance, a zero-valued in the weight sparsity tensor may indicate that the corresponding element in the weight tensor is zero. A one-valued in the weight sparsity tensor may indicate that the corresponding element in the weight tensor is non-zero.

Sparsity controller 1304 may generate a combined sparsity tensor using an activation sparsity tensor and a weight sparsity tensor. For instance, sparsity controller 1304 may multiply an element of the activation sparsity tensor with a corresponding element of the weight sparsity tensor to compute an element of the combined sparsity tensor. The positions of the three elements in their corresponding sparsity tensors may match. In some embodiments, each element in a sparsity tensor may be a bit, and the sparsity tensor may be referred to as a sparsity bitmap.

Sparsity controller 1304 may use the sparsity tensor to identify activations and weights to be used in MAC operations by the MAC units. In an embodiment where processing engine 1170 operates in the combined sparsity mode, sparsity controller 1304 may identify activations and weights that correspond to non-zero valued elements of a combined sparsity tensor. In an embodiment where processing engine 1170 operates in the activation sparsity mode, sparsity controller 1304 may identify activations and weights that correspond to non-zero valued elements of an activation sparsity tensor. In an embodiment where MAC array 1310 operates in the weight sparsity mode sparsity controller 1304 may identify activations and weights that correspond to non-zero valued elements of a weight sparsity tensor. The sparsity module may be bypassed in the dense mode as no sparsity acceleration would be conducted.

FIG. 14 illustrates sparse computation in sparse processing cell 1302, according to some embodiments of the disclosure. Sparse processing element 1400 may be a unit component of a processing cell, e.g., processing cell 1202 in the processing engine 1170, or sparse processing cell 1302 of FIG. 13. Phrased differently, a processing cell may have a grid or array of sparse processing elements, where an instance is shown as sparse processing element 1400.

In the embodiments of FIG. 14, sparse processing element 1400 includes an MAC unit 1405, activation register file 1410, weight register file 1420, output register file 1450, and sparsity accelerator 1460. MAC unit 1405 includes multiplier 1430 and adder 1440. In other embodiments, the sparse processing element 1400 may include fewer, more, or different components.

Activation register file 1410 stores an activation operand. Activation register file 1410 may be a part of activation data buffer 1308 of FIG. 13. Weight register file 1420 stores a weight operand. Weight register file 1420 may be a part of weight data buffer 1306. The activation operand and weight operand may be loaded from a memory (e.g., memory 1140 of FIG. 11) into activation register file 1410 and weight register file 1420, respectively.

Sparsity accelerator 1460 receives sparsity bitmap 1415 that corresponds to the sparse tensor in weight register file 1420. Sparsity bitmap 1415 may be generated by sparsity controller 1304 of FIG. 13. Sparsity bitmap 1415 may be a combined sparsity bitmap when MAC unit 1405 operates in a combined sparsity mode. Sparsity bitmap 1415 may be an activation sparsity bitmap when MAC unit 1405 operates in an activation sparsity mode. Sparsity bitmap 1415 may be a weight sparsity bitmap when MAC unit 1405 operates in a weight sparsity mode. Sparsity bitmap 1415 may have the same size (e.g., the same number of elements) as or a larger size than the activation operand or the weight operand.

Using sparsity bitmap 1415, sparsity accelerator 1460 selects, e.g., four activations from activation register file 1410 and selects four weights from weight register file 1420. Sparsity accelerator 1460 transmits the selected activations and weights to the multiplier 1430. These selected data elements correspond to the non-zero valued elements of sparsity bitmap 1415. The four selected activations and the four selected weights may constitute four activation-weight pairs. Multiplier 1430 may compute a product based on each activation-weight pair and therefore, compute four products in total. The four products may be provided to adder 1440. Even though FIG. 14 shows a single multiplier 1430, MAC unit 1405 may include multiple multipliers that can perform multiple multiplication operations at the same time.

Adder 1440 accumulates the four products and computes a unit-level internal partial sum. The four unselected elements of the dense tensor are not processed to save power and time, which would not impact the value of the unit-level internal partial sum. For instance, when the dense tensor is a dense activation tensor, the weights corresponding to the unselected activations are zero so the products of the unselected activations and the weights would all be zero and have no contribution to the unit-level internal partial sum or other partial sums computed by the sparse cell. Similarly, when the dense tensor is a dense weight tensor, the activations corresponding to the unselected weights are zero so the products of the unselected weights and the activations would all be zero and have no contribution to the unit-level internal partial sum or other partial sums computed by the sparse cell. In other embodiments, MAC unit 1405 may operate in a dense mode in which sparsity bitmap 1415 is not used and sparsity accelerator 1460 is inactive. MAC unit 1405 may process all the activations in the activation operand and all the weights in the weight operand.

The unit-level internal partial sum may be stored in output register file 1450. In some embodiments, the unit-level internal partial sum may be used multiple times. For instance, the activation operand may represent N data blocks in the input tensor of the convolution, where N is an integer greater than 1. Instead of processing all the N data blocks to compute N unit-level internal partial sums, the unit-level internal partial sum is computed once and used N times in the convolutional layers as N unit-level internal partial sums.

In some embodiments, sparse processing element 1400 receives one or more processing element level internal partial sums from one or more other processing elements of the processing cell. Adder 1440 or an accumulator (not shown in FIG. 14) can accumulate the one or more processing element level internal partial sums with the processing element level internal partial sum of sparse processing element 1400 and store the result of the accumulation (i.e., a multi-processing-element internal partial sum) in output register file 1450. The one or more other processing elements in the processing cell having a MAC array may be in the same column as sparse processing element 1400 in a sparse processing cell. The multi-unit internal partial sum may be a column-level internal partial sum. In some embodiments, the processing element level internal partial sum of sparse processing element 1400 or the multi-unit internal partial sum may be sent to one or more other processing elements in the processing cell for further accumulation.

Referring briefly back to FIGS. 4-5, the sparse CumSum mask can be provided as input to sparse processing cell 1302 as weight data. The sparsity data of the CumSum mask can be provided as input to sparsity controller 1304. Sparsity controller 1304 can accelerate CumBA execution by skipping MAC operations on zero-valued elements of the CumSum mask. Sparsity controller 1304 can support ZVC and sparse compute capabilities, making the DNN accelerator well-suited for efficiently handling such workloads. The sparsity bitmap produced by sparsity controller 1304 can allow the MAC array 1310 to efficiently skip unnecessary operations, leveraging both weight and activation sparsity. In particular, the sparsity bitmap can be used in sparse processing element 1400 to skip unnecessary operations. This dual approach can not only reduce memory usage but also decrease compute operations, accelerating the execution of CumSum and further enhancing energy efficiency for SSM-based DNN deployments.

FIG. 15 illustrates post-processing engine 1180, according to some embodiments of the disclosure. As discussed previously with FIG. 11, post-processing engine 1180 may process the output (e.g., a tensor) produced by processing engine 1170. Some exemplary components in post-processing engine 1180 are depicted. In some embodiments, post-processing engine 1180 may include bias 1502 to add a bias to the output produced by processing engine 1170. In some embodiments, post-processing engine 1180 may include scale 1504 to scale (e.g., multiply by a number) the output produced by processing engine 1170. In some embodiments, post-processing engine 1180 may include output conversion 1560, which may convert the data to different precisions such as integer precision, floating-point precision, etc. Output conversion 1560 may convert data between precisions such as INT8, FP16, FP32, etc. Output conversion 1560 may perform quantization according to a quantization specified in a configuration descriptor.

In some embodiments, post-processing engine 1180 may include a software programmable look-up table (LUT) 1588. LUT 1588 may be loaded with look-up table values provided in a configuration descriptor (e.g., from local memory 1140 and/or memory 1110), making LUT 1588 software configurable. The look-up table values include parameters for approximating a function, such as an activation function.

Examples of activation functions can include Swish, SiLU, SoftPlus, etc. LUT 1588 can be used to approximate the activation functions and apply the activation function on the outputs of the processing engine. The compiler can identify the activation functions (e.g., SoftPlus 804 of FIG. 8 and Swish 904 of FIG. 9) and map them to be processed by post-processing engine 1180, utilizing LUT 1588 to approximate the activation functions.

In some embodiments, post-processing engine 1180 may apply an approximated version (e.g., using linear approximation) of an activation function to the output produced by processing engine 1170 using LUT 1588. Post-processing engine 1180 may include address logic 1506, LUT 1588, and computation unit 1510, to apply the approximated version of the activation function. Specifically, LUT 1588 may store one or more look-up table values provided in a configuration descriptor that configures post-processing engine 1180. The look-up table values may approximate a function, such as an activation function or another suitable function. Specifically, the look-up table values include parameters for linear segments that approximate the activation function. The linear segments may correspond to different portions of the input range. In some cases, the look-up table values may include parameters for other types of segments, such as saturation segments or fixed segments. At different addresses of LUT 1588, LUT 1588 may store one or more look-up table values that specify the segments corresponding to a particular portion of the input range. Parameters for a linear segment can include a slope of a line and an intercept of the line corresponding to the linear segment.

When post-processing engine 1180 receives an input data element, address logic 1506 may identify the segment to which the input data element belongs, and therefore the location (e.g., address of LUT 1588) where parameters for the segments would be stored. Address logic 1506 may determine the address of LUT 1588 that is storing one or more look-up table values that can be used to calculate an approximation of the function being applied to the input data element (e.g., one or more parameters that specify the segment). The one or more look-up table values may be retrieved from LUT 1588 and provided to computation unit 1510. Computation unit 1510 may compute an output of a linear function corresponding to the linear segment using the one or more look-up table values, e.g., the one or more parameters that specify the linear segment. Computation unit 1510 may perform multiplication and adding to determine the output of the linear function. Specifically, computation unit 1510 may multiply the input data element by a slope of the linear function and add the result of the multiplication by an intercept of the linear function (where both the slope and the intercept may be stored in LUT 1588 at the address determined by address logic 1506). The output of the linear function calculated by computation unit 1510 serves as the approximated output of the function being approximated by LUT 1588. In another example where the input data element corresponds to a saturation segment, computation unit 1510 may be bypassed. A saturation value may be retrieved from LUT 1588 and used as the approximated output of the function being approximated by LUT 1588.

One or more outputs produced by post-processing engine 1180 may be provided to local memory 1140 of data processing unit 1130 via output module 1190 of FIG. 11.

FIG. 16 illustrates DNN module 1101, according to some embodiments of the disclosure. DNN module 1101 includes interface module 1610, training module 1620, validating module 1640, compiler 1650, and datastore 1660. In other embodiments, alternative configurations, different or additional components may be included in the DNN module 1101. Further, functionality attributed to a component of DNN module 1101 may be accomplished by a different component included in DNN module 1101 or a different module or system.

Interface module 1610 facilitates communications of DNN module 1101 with other modules or systems. For example, interface module 1610 establishes communications between DNN module 1101 with an external datastore to receive data that can be used to train DNNs or input into DNNs to perform tasks. As another example, interface module 1610 supports DNN module 1101 to distribute DNNs to other systems, e.g., computing devices configured to apply DNNs to perform tasks.

Training module 1620 trains DNNs by using a training dataset. Training module 1620 forms the training dataset. In an example where training module 1620 trains an DNN to recognize objects in images, the training dataset includes training images and training labels. The training labels describe ground-truth classifications of objects in the training images. In some embodiments, each label in the training dataset corresponds to an object in a training image. In an example where training module 1620 trains a transformer-based neural network to predict the next token, the training data set may include a large library of sequences of tokens. In some embodiments, a part of the training dataset may be used to initially train the DNN, and the rest of the training dataset may be held back as a validation subset used by validating module 1640 to validate performance of a trained DNN. The portion of the training dataset not including the tuning subset and the validation subset may be used to train the DNN.

Training module 1620 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 5, 10, 50, 100, 500, 1100, or even larger.

Training module 1620 can define the architecture of the DNN, e.g., based on some of the hyperparameters. In some cases, training module 1620 may receive a model definition that defines or specifies the architecture of the DNN. The architecture of the DNN can include a plurality of layers. Examples of layers may include convolutional layers, pooling layers, fully connected layers, normalization layers, SoftMax or logit layers, and so on. After training module 1620 defines the architecture of the DNN, training module 1620 inputs a training dataset into the DNN. The training dataset includes a plurality of training samples. The training module 1620 modifies the parameters inside the DNN (“internal parameters of the DNN”) to minimize the error between labels of the training objects that are generated by the DNN and the ground-truth labels of the objects. The internal parameters include weights used in layers of the DNN. In some embodiments, the training module 1620 uses a cost function to minimize the error.

Training module 1620 may train the DNN for a pre-determined number of epochs. The number of epochs is a hyperparameter that defines the number of times that the deep learning algorithm will work through the entire training dataset. One epoch means that each sample in the training dataset has had an opportunity to update internal parameters of the DNN. After training module 1620 finishes the pre-determined number of epochs, training module 1620 may stop updating the parameters in the DNN. The DNN having the updated parameters is referred to as a trained DNN.

Validating module 1640 verifies accuracy of trained DNNs. In some embodiments, validating module 1640 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, validating module 1640 may determine an accuracy score measuring the precision, recall, or a combination of precision and recall of the DNN. The validating module 1640 may use the following metrics to determine the accuracy score: Precision=TP/(TP+FP) and Recall=TP/(TP+FN), where precision may be how many the DNN correctly predicted (TP or true positives) out of the total it predicted (TP+FP or false positives), and recall may be how many the DNN correctly predicted (TP) out of the total number of objects that did have the property in question (TP+FN or false negatives). The F-score (F-score=2*PR/(P+R)) unifies precision and recall into a single measure.

Validating module 1640 may compare the accuracy score with a threshold score. In an example where validating module 1640 determines that the accuracy score of the DNN is less than the threshold score, validating module 1640 instructs training module 1620 to re-train the DNN. In one embodiment, training module 1620 may iteratively re-train the DNN until the occurrence of a stopping condition, such as the accuracy measurement indication that the DNN may be sufficiently accurate, or a number of training rounds having taken place.

Compiler 1650 compiles information associated with DNNs which can be used to cause or configure DNN accelerator 1102 of FIG. 11 to carry out neural network operations for DNNs. The information may include the model definition, one or more processing graphs, one or more data processing workloads produced from the one or more processing graphs, and executable instructions (e.g., workload descriptors, configuration descriptors, and/or low-level machine instructions) that can be executed by DNN accelerator 1102. The model definition may include one or more neural network operations to be performed by the DNN. In some embodiments, compiler 1650 may generate a processing graph representing a DNN. The graph may include nodes and edges. A node may represent a specific neural network operation in the DNN. An edge may connect two nodes and represent a connection between the two corresponding neural network operations. In an example, an edge may encode a tensor that flows from one of the neural network operations to the other neural network operation. The tensor may be an output tensor of the first neural network operation and an input tensor of the second neural network operation. The edge may encode one or more attributes of the tensor, such as size, shape, storage format, and so on.

Compiler 1650 may pre-process and/or modify the processing graph to identify opportunities to streamline the processing graph to reduce overhead of the compiled configuration descriptors. Due to the specific nature of the data processing pipeline in a DPU, compiler 1650 may follow a set of rules or patterns when producing one or more configuration descriptors for one or more nodes of the processing graph. Compiler 1650 may traverse through the processing graph to produce configuration descriptors according to the set of rules or patterns. The configuration descriptors can be used and executed by components of the DNN accelerator 1102 (e.g., processing engine 1170 and post-processing engine 1180 of FIG. 11) to execute the DNN.

Datastore 1660 stores data received, generated, used, or otherwise associated with the DNN module 1101. For example, datastore 1660 stores the datasets used by training module 1620 and validating module 1640. Datastore 1660 may also store data generated by training module 1620 and validating module 1640, such as the hyperparameters for training DNNs, internal parameters of trained DNNs (e.g., weights, etc.), data for sparsity acceleration (e.g., sparsity bitmap, etc.), and so on. Datastore 1660 may store configuration parameters, configuration descriptors, instructions generated by compiler 1650, etc. The datastore 1660 may include one or more memories. In the embodiment of FIG. 16, datastore 1660 is a component of DNN module 1101. In other embodiments, datastore 1660 may be external to DNN module 1101 and communicate with the DNN module 1101 through a network.

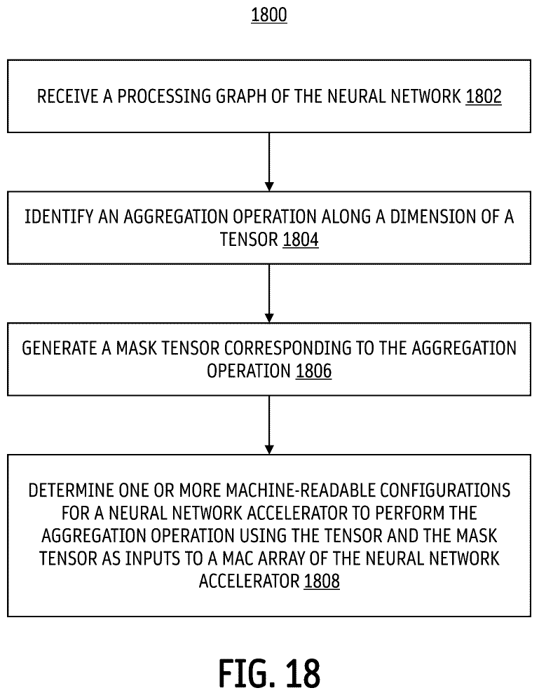

FIG. 17 illustrates compiler 1650, according to some embodiments of the disclosure. To take advantage of compiler optimizations (CumBA, ReduBa, and ActiBA) as discussed herein, compiler 1650 may implement operations as described in methodology 1000 of FIG. 10, in particular, the operations described in model compilation 1010 of FIG. 10. Compiler 1650 includes neural network analyzer 1702, map aggregation operation to DPU 1704, map activation function operation to post-processing engine 1706, configuration descriptors generator 1708, and scheduler 1710. Compiler 1650 may perform method 1800 of FIG. 18.

Neural network analyzer 1702 may analyze a DNN (e.g., a model definition) and determine how a neural network hardware accelerator can implement the DNN utilizing the components of the DNN accelerator. Neural network analyzer 1702 may receive the neural network model definition of the DNN. A neural network model definition may specify one or more layers of a neural network. For example, a neural network model definition may specify layers of the neural network and how the data should flow through the layers. A layer can be specified by the neural network operation that the layer performs. Examples of layers can include fully connected (linear) layer, convolutional layer, recurrent layer, long short-term memory network, gated recurrent unit layer, max pooling layer, average pooling layer, batch normalization layer, normalization layer, dropout layer, activation layer, embedding layer, etc. The layer can be specified by one or more of: input size, hidden size, output size, etc. The layer can be specified by one or more parameters of the neural network operation (e.g., for a convolutional layer, one or more parameters may include kernel size, padding, stride, etc.).

In some cases, neural network analyzer 1702 may determine a processing graph based on the neural network model definition. A processing graph may include connected nodes. The connected nodes can represent neural network operations to be executed by one or more data processing units or other components of the DNN accelerator and an order of execution of the neural network operations. The edges connecting the nodes can represent the flow of data between the neural network operations. Examples of neural network operations can include: a compute operation, convolution, filtering, pooling, arithmetic, matrix multiplication, applying an activation function (clamping function, exponential function, sigmoid function, power function, square root function, etc.), etc. An edge connecting a node and a further node that follows the node may represent that an output generated by the node is to be provided as an input to the further node. The processing graph may include one or more neural network operations to be executed by one or more DPUs (of the neural network hardware accelerator).

Neural network analyzer 1702 may determine one or more data processing workloads to be carried out by the DPUs (of the neural network hardware accelerator) based on the processing graph and/or the neural network model definition. The one or more data processing workloads may correspond to and/or include one or more neural network operations of the processing graph. For example, a data processing workload may include one or more neural network operations to be executed according to one or more configurations. The data processing workload may be executed by a data processing pipeline of a data processing unit, such as a processing engine of a data processing unit, or a post-processing engine of a data processing unit. In some cases, a neural network operation may translate to a data processing workload. In some cases, a neural network operation may translate to multiple data processing workloads. In some cases, one or more neural network operations may translate to one or more data processing workloads. The neural network operations can be executed by a data processing pipeline of a data processing unit, such as a processing engine of a data processing unit, or a post-processing engine of a data processing unit. The neural network operations can be executed by one or more data processing units or one or more parts of a data processing unit, according to the order of execution represented by the processing graph. A neural network operation of a data processing workload may be executed by a data processing unit according to one or more configurations for the neural network operation. In some cases, the neural network model definition includes the processing graph.

As illustrated by FIGS. 3-10 and discussed herein, there are opportunities for identifying certain operations and mapping them onto the DPU to improve execution efficiency.

Map aggregation operation to DPU 1704 may traverse through the processing graph determined by neural network analyzer 1702 to identify an aggregation operation, such as CumSum operation and ReduceSum operation. Map aggregation operation to DPU 1704 may map the aggregation operation to be executed on the DPU, e.g., executed by the MAC array in the processing engine of the DPU to carry out matrix-to-matrix multiplication or matrix-to-vector multiplication, as opposed to executing the aggregation operation on the DSP. Map aggregation operation to DPU 1704 may generate the mask tensor for performing the aggregation operation. Mapping the aggregation operation to be executed on the processing engine of the DPU may flag the aggregation operation to cause configuration descriptors generator 1708 to generate suitable machine-readable configurations to configure the DPU (e.g., the MAC array) to perform matrix-to-matrix multiplication or matrix-to-vector multiplication utilizing the mask tensor.

Map activation function operation to post-processing engine 1706 may traverse through the processing graph determined by neural network analyzer 1702 to identify a data-parallel operation followed by an activation function operation. Map activation function operation to post-processing engine 1706 may map the pattern of operations to be executed on the DPU in a fused manner, e.g., the data-parallel operation is executed by the MAC array in the DPU, and the activation function is executed by the post-processing engine using the Spr-LUT, as opposed to executing the activation function operation on the DSP. Map activation function operation to post-processing engine 1706 may generate or determine the entries for the Spr-LUT that can approximate the activation function. Mapping the activation function operation to be executed on DPU using the post-processing engine may flag the activation function operation to cause configuration descriptors generator 1708 to generate suitable machine-readable configurations that can load the look-up table of the post-processing engine of the DPU with the look-up table entries determined at compile time.

Configuration descriptors generator 1708 may generate one or more instructions (e.g., one or more configuration descriptors, one or more workload descriptors, low-level machine instructions, one or more machine-readable configurations, etc.) based on the data processing graph, e.g., whether an operation is flagged to be executed on the DPU (e.g., using the processing engine or the post-processing engine).

Scheduler 1710 may coordinate when and which DPUs should have the configuration descriptors generated by configuration descriptors generator 1708 loaded to execute the data processing workloads. The data processing workloads may be allocated by scheduler 1710 to the DPUs (in a neural network hardware accelerator), and scheduler 1710 may coordinate to have the corresponding configuration descriptors (or one or more parts of a configuration descriptor) provided to the DPUs. In some cases, scheduler 1710 may determine a plan that can load balance execution of the data processing workloads. Scheduler 1710 may determine a plan that ensures the data processing workloads are being executed according to the processing graph. Scheduler 1710 may determine a plan to cause a configuration descriptor or a portion of a configuration descriptor to be loaded onto a DPU at an appropriate time. In some cases, scheduler 1710 may be a part of compiler 1650. In some cases, scheduler 1710 may be a part of DNN module 1101 of FIGS. 11 and 16.

Referring back to FIGS. 11-17, DNN system 1100 illustrates one implementation of a processing system designed to accelerate execution of DNNs. The architecture design of a DNN accelerator 1102 can vary depending on the application requirements of the processor. The architecture design can vary based on the number of DPUs, the number of processing engines, the number of processing cells, the number of post-processing engines, structure of the data processing pipeline in a DPU, support for vector processing, support for sparsity modes, the types or collection of processing elements, amount of memory and buffer size, etc. The underlying hardware implementation of process can include other computing technologies, such as compute-in-memory technologies (including analog compute-in-memory technologies and digital compute-in-memory technologies).

### Exemplary Methods for the Compiler

FIG. 18 depicts a flow diagram illustrating method 1800 that can be carried out by a compiler, according to some embodiments of the disclosure. Method 1800 can be performed to compile a neural network.

In 1802, the compiler receives a processing graph of the neural network comprising connected neural network operations. The neural network can include one or more state space models, and/or one or more Mamba blocks (e.g., Mamba block 102 of FIG. 1). The connected neural network operations of the processing graph can represent a variety of mathematical and/or logical operations (e.g., such as operations seen in FIG. 1) that are to be performed by the neural network to transform an input and produce an output. For an SSM-based model, the connected neural network operations can include an aggregation operation (ReduceSum and/or CumSum), an activation function (SoftPlus, SiLU, and/or Swish).

In 1804, the compiler identifies an aggregation operation along a dimension of a tensor in the connected neural network operations of the processing graph. The aggregation operation can include CumSum operation. The aggregation operation can include ReduceSum operation. Identifying the aggregation operation. In response to identifying the aggregation operation, the compiler can map the aggregation operation to be performed on the tensor using a MAC array of the neural network accelerator.

Herein, identifying an operation in the connected neural network operations can involve analyzing and/or traversing through the processing graph to determine whether a given connected neural network operation is an operation of interest, such as an aggregation operation (ReduceSum and/or CumSum), an activation function (SoftPlus, SiLU, and/or Swish).

In 1806, the compiler generates, e.g., at compile time, a mask tensor corresponding to the aggregation operation. If the aggregation operation is a ReduceSum operation, the mask tensor is a lower-triangular binary matrix comprising ones on and below a diagonal and zeros above the diagonal. If the aggregation operation is a CumSum operation, the mask tensor is a shifting and/or saturating pattern of ones. The mask tensor enables the MAC array to perform an aggregation operation using the accumulation circuitry of the MAC array by multiplying appropriate elements of the tensor with ones and accumulating the multiplication results along the appropriate dimension in a data-parallel manner.

In 1808, the compiler determines one or more machine-readable configurations for configuring a multiply-and-accumulate array of a neural network accelerator to perform the aggregation operation using the mask tensor as an input to the multiply-and accumulate array and the tensor as a further input to the multiply-and accumulate array.

### Exemplary Methods for the DNN Accelerator

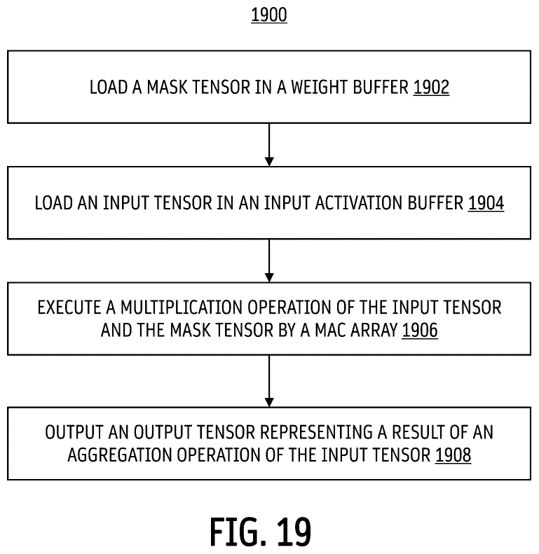

FIG. 19 depicts a flow diagram illustrating method 1900 that can be carried out by a neural network accelerator, according to some embodiments of the disclosure. Method 1900 can be performed to execute operations of a neural network.

In 1902, the neural network accelerator can load a mask tensor in a weight buffer of a neural network accelerator.

In 1904, the neural network accelerator can load an input tensor of the neural network in an input activation buffer of the neural network accelerator.

In 1906, a multiply-and-accumulate array of the neural network accelerator can execute a multiplication operation of the input tensor with the mask tensor.

In 1908, the multiply-and-accumulate array can output an output tensor of the neural network representing a result of an aggregation operation on the input tensor. The aggregation operation can include CumSum operation. The aggregation operation can include ReduceSum operation.

### Exemplary Computing Device

FIG. 20 is a block diagram of an apparatus or a system, e.g., an exemplary computing device 2000, according to some embodiments of the disclosure. One or more computing devices 2000 may be used to implement the functionalities described with the FIGS. and herein. A number of components illustrated in FIG. 20 can be included in the computing device 2000, but any one or more of these components may be omitted or duplicated, as suitable for the application. In some embodiments, some or all of the components included in the computing device 2000 may be attached to one or more motherboards. In some embodiments, some or all of these components are fabricated onto a single System on a Chip (SoC) die. Additionally, in various embodiments, the computing device 2000 may not include one or more of the components illustrated in FIG. 20, and the computing device 2000 may include interface circuitry for coupling to the one or more components. For example, the computing device 2000 may not include a display device 2006, and may include display device interface circuitry (e.g., a connector and driver circuitry) to which a display device 2006 may be coupled. In another set of examples, the computing device 2000 may not include an audio input device 2018 or an audio output device 2008 and may include audio input or output device interface circuitry (e.g., connectors and supporting circuitry) to which an audio input device 2018 or audio output device 2008 may be coupled.

Computing device 2000 may include a processing device 2002 (e.g., one or more processing devices, one or more of the same types of processing device, one or more of different types of processing device). The processing device 2002 may include electronic circuitry that processes electronic data from data storage elements (e.g., registers, memory, resistors, capacitors, quantum bit cells) to transform that electronic data into other electronic data that may be stored in registers and/or memory. Examples of processing device 2002 may include a CPU, a GPU, a quantum processor, a machine learning processor, an AI processor, a neural network processor, an AI accelerator, an application specific integrated circuit (ASIC), an analog signal processor, an analog computer, a microprocessor, a digital signal processor, a field programmable gate array (FPGA), a tensor processing unit (TPU), a neural network hardware accelerator, a DNN accelerator (e.g., DNN accelerator 1102 as illustrated in FIGS. 11-15), NPU, etc.

Computing device 2000 may include a memory 2004, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 2004 includes one or more non-transitory computer-readable storage media. In some embodiments, memory 2004 may include memory that shares a die with the processing device 2002.

In some embodiments, memory 2004 includes one or more non-transitory computer-readable media storing instructions executable to perform operations described with the FIGS. and herein. Exemplary parts, e.g., DNN module 1101 and compiler 1650, that may be encoded as instructions and stored in memory 2004 are depicted. Memory 2004 may store instructions that encode one or more exemplary parts, such as DNN module 1101, one or more parts of DNN module 1101, compiler 1650, one or more parts of compiler 1650. The instructions stored in the one or more non-transitory computer-readable media may be executed by processing device 2002. Memory 2004 may store instructions that causes processing device 2002 to perform one or more methods described and illustrated herein, such as methodology 1000, method 1800, and method 1900.

In some embodiments, memory 2004 may store data, e.g., data structures, binary data, bits, metadata, files, blobs, etc., as described with the FIGS. and herein.

In some embodiments, memory 2004 may store one or more DNNs (and or parts thereof). Memory 2004 may store training data for training (trained) a DNN. Memory 2004 may store instructions that perform operations associated with training a DNN. Memory 2004 may store input data, output data, intermediate outputs, intermediate inputs of one or more DNNs. Memory 2004 may store one or more parameters used by the one or more DNNs. Memory 2004 may store information that encodes how nodes of the one or more DNNs are connected with each other. Memory 2004 may store instructions to perform one or more operations of the one or more DNNs. Memory 2004 may store a model definition that specifies one or more operations of a DNN. Memory 2004 may store instructions, such as configuration descriptors or the model blob, that are generated by a compiler based on the model definition. Memory 2004 may store data depicted with methodology 1000 of FIG. 10.

In some embodiments, computing device 2000 may include a communication device 2012 (e.g., one or more communication devices). For example, the communication device 2012 may be configured for managing wired and/or wireless communications for the transfer of data to and from the computing device 2000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 2012 may implement any of a number of wireless standards or protocols, including but not limited to Institute for Electrical and Electronic Engineers (IEEE) standards including Wi-Fi (IEEE 1202.10 family), IEEE 1202.16 standards (e.g., IEEE 1202.16-1605 Amendment), Long-Term Evolution (LTE) project along with any amendments, updates, and/or revisions (e.g., advanced LTE project, ultramobile broadband (UMB) project (also referred to as “3GPP2”), etc.). IEEE 1202.16 compatible Broadband Wireless Access (BWA) networks are generally referred to as WiMAX networks, an acronym that stands for worldwide interoperability for microwave access, which is a certification mark for products that pass conformity and interoperability tests for the IEEE 1202.16 standards. Communication device 2012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication device 2012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication device 2012 may operate in accordance with other wireless protocols in other embodiments. The computing device 2000 may include an antenna 2022 to facilitate wireless communications and/or to receive other wireless communications (such as radio frequency transmissions). Computing device 2000 may include receiver circuits and/or transmitter circuits. In some embodiments, Communication device 2012 may manage wired communications, such as electrical, optical, or any other suitable communication protocols (e.g., the Ethernet). As noted above, the communication device 2012 may include multiple communication chips. For instance, a first communication device 2012 may be dedicated to shorter-range wireless communications such as Wi-Fi or Bluetooth, and a second communication device 2012 may be dedicated to longer-range wireless communications such as global positioning system (GPS), EDGE, GPRS, CDMA, WiMAX, LTE, EV-DO, or others. In some embodiments, a first communication device 2012 may be dedicated to wireless communications, and a second communication device 2012 may be dedicated to wired communications.

Computing device 2000 may include power source/power circuitry 2014. The power source/power circuitry 2014 may include one or more energy storage devices (e.g., batteries or capacitors) and/or circuitry for coupling components of the computing device 2000 to an energy source separate from the computing device 2000 (e.g., DC power, AC power, etc.).

Computing device 2000 may include a display device 2006 (or corresponding interface circuitry, as discussed above). The display device 2006 may include any visual indicators, such as a heads-up display, a computer monitor, a projector, a touchscreen display, a liquid crystal display (LCD), a light-emitting diode display, or a flat panel display, for example.

Computing device 2000 may include an audio output device 2008 (or corresponding interface circuitry, as discussed above). The audio output device 2008 may include any device that generates an audible indicator, such as speakers, headsets, or earbuds, for example.

Computing device 2000 may include an audio input device 2018 (or corresponding interface circuitry, as discussed above). The audio input device 2018 may include any device that generates a signal representative of a sound, such as microphones, microphone arrays, or digital instruments (e.g., instruments having a musical instrument digital interface (MIDI) output).

Computing device 2000 may include a GPS device 2016 (or corresponding interface circuitry, as discussed above). The GPS device 2016 may be in communication with a satellite-based system and may receive a location of the computing device 2000, as known in the art.

Computing device 2000 may include a sensor 2030 (or one or more sensors). Computing device 2000 may include corresponding interface circuitry, as discussed above). Sensor 2030 may sense physical phenomenon and translate the physical phenomenon into electrical signals that can be processed by, e.g., processing device 2002. Examples of sensor 2030 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 2000 may include another output device 2010 (or corresponding interface circuitry, as discussed above). Examples of the other output device 2010 may include an audio codec, a video codec, a printer, a wired or wireless transmitter for providing information to other devices, haptic output device, gas output device, vibrational output device, lighting output device, home automation controller, or an additional storage device.

Computing device 2000 may include another input device 2020 (or corresponding interface circuitry, as discussed above). Examples of the other input device 2020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 2000 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 2000 may be any other electronic device that processes data.

### Select Examples

Example 1 provides an apparatus, including a processor; and a memory to store instructions, that when executed by the processor, cause the processor: receive a processing graph including connected neural network operations, the processing graph corresponding to a neural network; identify an aggregation operation along a dimension of a tensor in the connected neural network operations of the processing graph; generate a mask tensor corresponding to the aggregation operation; and determine one or more machine-readable configurations for a neural network accelerator to perform the aggregation operation using the tensor and the mask tensor as inputs to a multiply-and-accumulate array of the neural network accelerator.
Example 2 provides the apparatus of example 1, where the aggregation operation includes a cumulative sum operation along the dimension of the tensor.
Example 3 provides the apparatus of example 1 or 2, where the mask tensor is a lower-triangular binary matrix including ones on and below a diagonal and zeros above the diagonal.
Example 4 provides the apparatus of any one of examples 1-3, where the one or more machine-readable configurations configure the multiply-and-accumulate array of the neural network accelerator to perform matrix-to-matrix multiplication of the tensor and the mask tensor.
Example 5 provides the apparatus of example 1, where the aggregation operation includes a reduce sum operation along the dimension of the tensor.
Example 6 provides the apparatus of example 1 or 5, where the mask tensor is a vector mask including a saturating pattern of ones.
Example 7 provides the apparatus of any one of examples 1-6, where the connected neural network operations includes a plurality of operations associated with a state space model, and the plurality of operations associated with the state space model includes the aggregation operation.
Example 8 provides the apparatus of any one of examples 1 and 5-7, where the one or more machine-readable configurations configure the multiply-and-accumulate array of the neural network accelerator to perform matrix-to-vector multiplication of the tensor and the mask tensor.
Example 9 provides the apparatus of any one of examples 1-8, where the instructions further cause the processor to: identify an operation and an activation function operation following the operation in the connected neural network operations of the processing graph; and determine one or more further machine-readable configurations for configuring the multiply-and-accumulate array of the neural network accelerator to perform the operation and a look-up table of a post-processing engine to store one or more slopes and one or more intercepts of one or more segments of an activation function being applied in the activation function operation.
Example 10 provides the apparatus of example 9, where the post-processing engine has a data signal path directly coupling the post-processing engine to the multiply-and-accumulate array.
Example 11 provides the apparatus of any one of examples 1-10, where the instructions further cause the processor to: compress one or more weights of the neural network.
Example 12 provides the apparatus of any one of examples 1-10, where the instructions further cause the processor to: generate a model blob that is executable by the neural network accelerator based on the one or more machine-readable configurations.
Example 13 provides one or more non-transitory computer-readable media storing instructions, that when executed by a processor, cause the processor to: receive a processing graph of a neural network, the processing graph including connected neural network operations; identify an aggregation operation along a dimension of a tensor in the connected neural network operations of the processing graph; generating a mask tensor corresponding to the aggregation operation; and determine one or more machine-readable configurations for configuring a neural network accelerator to perform the aggregation operation using the tensor and the mask tensor as inputs to a multiply-and-accumulate array of the neural network accelerator.
Example 14 provides the one or more non-transitory computer-readable media of example 13, where the aggregation operation includes a cumulative sum operation along the dimension of the tensor.
Example 15 provides the one or more non-transitory computer-readable media of example 13 or 14, where the mask tensor is a lower-triangular binary matrix including ones on and below a diagonal and zeros above the diagonal.
Example 16 provides the one or more non-transitory computer-readable media of any one of examples 13-15, where the one or more machine-readable configurations configure the multiply-and-accumulate array of the neural network accelerator to perform matrix-to-matrix multiplication of the tensor and the mask tensor.
Example 17 provides the one or more non-transitory computer-readable media of example 13, where the aggregation operation includes a reduce sum operation along the dimension of the tensor.
Example 18 provides the one or more non-transitory computer-readable media of example 13 or 17, where the mask tensor is a vector mask including a saturating pattern of ones.
Example 19 provides the one or more non-transitory computer-readable media of any one of examples 13-18, where the connected neural network operations includes a plurality of operations associated with a state space model, and the plurality of operations associated with the state space model includes the aggregation operation.
Example 20 provides the one or more non-transitory computer-readable media of any one of examples 13 and 17-19, where the one or more machine-readable configurations configure the multiply-and-accumulate array of the neural network accelerator to perform matrix-to-vector multiplication of the tensor and the mask tensor.
Example 21 provides the one or more non-transitory computer-readable media of any one of examples 13-20, where the instructions further cause the processor to: identify an operation and an activation function operation following the operation in the connected neural network operations of the processing graph; and determine one or more further machine-readable configurations for configuring the multiply-and-accumulate array of the neural network accelerator to perform the operation and a look-up table of a post-processing engine to store one or more slopes and one or more intercepts of one or more segments of an activation function being applied in the activation function operation.
Example 22 provides the one or more non-transitory computer-readable media of example 21, where the post-processing engine has a data signal path directly coupling the post-processing engine to the multiply-and-accumulate array.
Example 23 provides the one or more non-transitory computer-readable media of any one of examples 13-22, where the instructions further cause the processor to: compress one or more weights of the neural network.
Example 24 provides the one or more non-transitory computer-readable media of any one of examples 13-23, where the instructions further cause the processor to: generate a model blob that is executable by the neural network accelerator based on the one or more machine-readable configurations.
Example 25 provides a method for compiling a neural network, including receiving a processing graph of the neural network including connected neural network operations; identifying an aggregation operation along a dimension of a tensor in the connected neural network operations of the processing graph; generating a mask tensor corresponding to the aggregation operation; and determining one or more machine-readable configurations for configuring a neural network accelerator to perform the aggregation operation using the tensor and the mask tensor as inputs to a multiply-and-accumulate array of the neural network accelerator.
Example 26 provides the method of example 25, where the aggregation operation includes a cumulative sum operation along the dimension of the tensor.
Example 27 provides the method of example 25 or 26, where the mask tensor is a lower-triangular binary matrix including ones on and below a diagonal and zeros above the diagonal.
Example 28 provides the method of any one of examples 25-26, where the one or more machine-readable configurations configure the multiply-and-accumulate array of the neural network accelerator to perform matrix-to-matrix multiplication of the tensor and the mask tensor.
Example 29 provides the method of example 25, where the aggregation operation includes a reduce sum operation along the dimension of the tensor.
Example 30 provides the method of example 25 or 29, where the mask tensor is a vector mask including a saturating pattern of ones.
Example 31 provides the method of any one of examples 25-30, where the connected neural network operations includes a plurality of operations associated with a state space model, and the plurality of operations associated with the state space model includes the aggregation operation.
Example 32 provides the method of any one of examples 25 and 29-31, where the one or more machine-readable configurations configure the multiply-and-accumulate array of the neural network accelerator to perform matrix-to-vector multiplication of the tensor and the mask tensor.
Example 33 provides the method of any one of examples 25-32, further including identifying an operation and an activation function operation following the operation in the connected neural network operations of the processing graph; and determining one or more further machine-readable configurations for configuring the multiply-and-accumulate array of the neural network accelerator to perform the operation and a look-up table of a post-processing engine to store one or more slopes and one or more intercepts of one or more segments of an activation function being applied in the activation function operation.
Example 34 provides the method of example 33, where the post-processing engine has a data signal path directly coupling the post-processing engine to the multiply-and-accumulate array.
Example 35 provides the method of any one of examples 25-34, further including compressing one or more weights of the neural network.
Example 36 provides the method of any one of examples 25-35, further including generating a model blob that is executable by the neural network accelerator based on the one or more machine-readable configurations.
Example 37 provides a neural network accelerator, including a weight buffer to store a mask tensor; an input activation buffer to store an input tensor of a neural network; and a multiply-and-accumulate array to perform a multiplication operation of the input tensor with the mask tensor to output an output tensor of the neural network representing a result of an aggregation operation on the input tensor.
Example 38 provides the neural network accelerator of example 37, where the aggregation operation includes a cumulative sum operation along a dimension of the input tensor.
Example 39 provides the neural network accelerator of example 37 or 38, where the mask tensor is a lower-triangular binary matrix including ones on and below a diagonal and zeros above the diagonal.
Example 40 provides the neural network accelerator of any one of examples 37-39, where the multiply-and-accumulate array is to perform a matrix-to-matrix multiplication of the input tensor and the mask tensor to output the output tensor.
Example 41 provides the neural network accelerator of example 37, where the aggregation operation includes a reduce sum operation along a dimension of the input tensor.
Example 42 provides the neural network accelerator of example 37 or 41, where the mask tensor is a vector mask including a saturating pattern of ones.
Example 43 provides the neural network accelerator of any one of examples 37 and 41-42, where the multiply-and-accumulate array is to perform matrix-to-vector multiplication of the input tensor and the mask tensor to output the output tensor.
Example 44 provides the neural network accelerator of any one of examples 37 and 41-43, where the mask tensor is stored on the weight buffer and reused for a plurality of compute cycles of the multiply-and-accumulate array.
Example 45 provides the neural network accelerator of any one of examples 37-44, further including a further weight buffer to store the mask tensor; a further input activation buffer to store a further input tensor; and a further multiply-and-accumulate array to perform a further multiplication operation of the further input tensor with the mask tensor to output a further output tensor representing a further result of the aggregation operation on the further input tensor.
Example 46 provides the neural network accelerator of any one of examples 37-45, further including a post-processing engine having a look-up table to store one or more slopes and one or more intercepts of one or more segments of an activation function; and a data signal path directly coupling the post-processing engine to the multiply-and-accumulate array.
Example 47 provides the neural network accelerator of any one of examples 37-46, further including a sparsity controller to receive sparsity data of the mask tensor and select dense data of the mask tensor to be forwarded to processing cells of the multiply-and-accumulate array.
Example 48 provides a non-transitory computer-readable medium storing machine-readable configurations to configure a neural network accelerator to: load a mask tensor in a weight buffer of the neural network accelerator; load an input tensor of a neural network in an input activation buffer of the neural network accelerator; execute, by a multiply-and-accumulate array of the neural network accelerator, a multiplication operation of the input tensor with the mask tensor; and output an output tensor of the neural network representing a result of an aggregation operation on the input tensor.
Example 49 provides the non-transitory computer-readable medium of example 48, where the aggregation operation includes a cumulative sum operation along a dimension of the input tensor.
Example 50 provides the non-transitory computer-readable medium of example 48 or 49, where the mask tensor is a lower-triangular binary matrix including ones on and below a diagonal and zeros above the diagonal.
Example 51 provides the non-transitory computer-readable medium of any one of examples 48-50, where executing the multiplication operation includes executing a matrix-to-matrix multiplication of the input tensor and the mask tensor to output the output tensor.
Example 52 provides the non-transitory computer-readable medium of example 48, where the aggregation operation includes a reduce sum operation along a dimension of the input tensor.
Example 53 provides the non-transitory computer-readable medium of example 48 or 52, where the mask tensor is a vector mask including a saturating pattern of ones.
Example 54 provides the non-transitory computer-readable medium of any one of examples 48 and 52-53, where executing the multiplication operation includes executing matrix-to-vector multiplication of the input tensor and the mask tensor to output the output tensor.
Example 55 provides the non-transitory computer-readable medium of any one of examples 48-54, where the machine-readable configurations further cause the neural network accelerator to: load one or more slopes and one or more intercepts of one or more segments of an activation function in a look-up table of a post-processing engine, where the post-processing engine is directly coupled to the multiply-and-accumulate array.
Example 56 provides the non-transitory computer-readable medium of any one of examples 48-55, where the machine-readable configurations further cause the neural network accelerator to: provide sparsity data of the mask tensor to a sparsity controller to cause the sparsity controller to select dense data of the mask tensor to be forwarded to processing cells of the multiply-and-accumulate array.
Example 57 provides a method for executing operations of a neural network, the method including loading a mask tensor in a weight buffer of a neural network accelerator; loading an input tensor of the neural network in an input activation buffer of the neural network accelerator; executing, by a multiply-and-accumulate array of the neural network accelerator, a multiplication operation of the input tensor with the mask tensor; and outputting an output tensor of the neural network representing a result of an aggregation operation on the input tensor.
Example 58 provides the method of example 57, where the aggregation operation includes a cumulative sum operation along a dimension of the input tensor.
Example 59 provides the method of example 57 or 58, where the mask tensor is a lower-triangular binary matrix including ones on and below a diagonal and zeros above the diagonal.
Example 60 provides the method of any one of examples 57-59, where executing the multiplication operation includes executing a matrix-to-matrix multiplication of the input tensor and the mask tensor to output the output tensor.
Example 61 provides the method of example 57, where the aggregation operation includes a reduce sum operation along a dimension of the input tensor.
Example 62 provides the method of example 57 or 61, where the mask tensor is a vector mask including a saturating pattern of ones.
Example 63 provides the method of any one of examples 57 and 61-62, where the multiply-and-accumulate array of the neural network accelerator is to perform matrix-to-vector multiplication of the input tensor and the mask tensor to output the output tensor.
Example 64 provides the method of any one of examples 57-63, further including loading one or more slopes and one or more intercepts of one or more segments of an activation function in a look-up table of a post-processing engine, where the post-processing engine is directly coupled to the multiply-and-accumulate array.
Example 65 provides the method of any one of examples 57-64, further including providing sparsity data of the mask tensor to a sparsity controller to cause the sparsity controller to select dense data of the mask tensor to be forwarded to processing cells of the multiply-and-accumulate array.
Example 66 provides an apparatus including means for performing a method according to any one of examples 25-36 and 27-65.
Example 67 provides a computer program product including instructions which, when executed by a processor, cause the processor to perform a method according to any one of examples 25-36 and 27-65.
Example 68 provides machine-readable storage including machine-readable instructions, when executed, cause a computer to implement a method according to any one of examples 25-36 and 27-65.
Example 69 provides a computer program including instructions which, when the computer program is executed by a processing device, cause the processing device to carry out a method according to any one of examples 25-36 and 27-65.
Example 70 provides a computer-implemented system, including one or more processors, and one or more non-transitory computer-readable media storing instructions that, when executed by the one or more processors, cause the one or more processors to perform a method according to any one of examples 25-36 and 27-65.

### Variations and Other Notes

Although the operations of the example method shown in and described with reference to FIGS. are illustrated as occurring once each and in a particular order, it will be recognized that some operations may be performed in any suitable order and repeated as desired. Furthermore, the operations illustrated in FIGS. may be combined or may include more or fewer details than described.

The various implementations described herein may refer to AI, machine learning, and deep learning. Deep learning may be a subset of machine learning. Machine learning may be a subset of AI. In cases where a deep learning model is mentioned, if suitable for a particular application, a machine learning model may be used instead. In cases where a deep learning model is mentioned, if suitable for a particular application, a digital signal processing system may be used instead.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

For the purposes of the present disclosure, “A is less than or equal to a first threshold” is equivalent to “A is less than a second threshold” provided that the first threshold and the second thresholds are set in a manner so that both statements result in the same logical outcome for any value of A. For the purposes of the present disclosure, “B is greater than a first threshold” is equivalent to “B is greater than or equal to a second threshold” provided that the first threshold and the second thresholds are set in a manner so that both statements result in the same logical outcome for any value of B.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An apparatus, comprising:
a processor; and
a memory to store instructions, that when executed by the processor, cause the processor:
receive a processing graph comprising connected neural network operations, the processing graph corresponding to a neural network;
identify an aggregation operation along a dimension of a tensor in the connected neural network operations of the processing graph;
generate a mask tensor corresponding to the aggregation operation; and
determine one or more machine-readable configurations for a neural network accelerator to perform the aggregation operation using the tensor and the mask tensor as inputs to a multiply-and-accumulate array of the neural network accelerator.

2. The apparatus of claim 1, wherein the aggregation operation comprises a cumulative sum operation along the dimension of the tensor.

3. The apparatus of claim 1, wherein the mask tensor is a lower-triangular binary matrix comprising ones on and below a diagonal and zeros above the diagonal.

4. The apparatus of claim 1, wherein the one or more machine-readable configurations configure the multiply-and-accumulate array of the neural network accelerator to perform matrix-to-matrix multiplication of the tensor and the mask tensor.

5. The apparatus of claim 1, wherein the aggregation operation comprises a reduce sum operation along the dimension of the tensor.

6. The apparatus of claim 1, wherein the mask tensor is a vector mask comprising a saturating pattern of ones.

7. The apparatus of claim 1, wherein the connected neural network operations comprises a plurality of operations associated with a state space model, and the plurality of operations associated with the state space model includes the aggregation operation.

8. The apparatus of claim 1, wherein the one or more machine-readable configurations configure the multiply-and-accumulate array of the neural network accelerator to perform matrix-to-vector multiplication of the tensor and the mask tensor.

9. The apparatus of claim 1, wherein the instructions further cause the processor to:
identify an operation and an activation function operation following the operation in the connected neural network operations of the processing graph; and
determine one or more further machine-readable configurations for configuring the multiply-and-accumulate array of the neural network accelerator to perform the operation and a look-up table of a post-processing engine to store one or more slopes and one or more intercepts of one or more segments of an activation function being applied in the activation function operation.

10. The apparatus of claim 9, wherein the post-processing engine has a data signal path directly coupling the post-processing engine to the multiply-and-accumulate array.

11. The apparatus of claim 1, wherein the instructions further cause the processor to:
compress one or more weights of the neural network.

12. The apparatus of claim 1, wherein the instructions further cause the processor to:
generate a model blob that is executable by the neural network accelerator based on the one or more machine-readable configurations.

13. One or more non-transitory computer-readable media storing instructions, that when executed by a processor, cause the processor to:
receive a processing graph of a neural network, the processing graph comprising connected neural network operations;
identify an aggregation operation along a dimension of a tensor in the connected neural network operations of the processing graph;
generating a mask tensor corresponding to the aggregation operation; and
determine one or more machine-readable configurations for configuring a neural network accelerator to perform the aggregation operation using the tensor and the mask tensor as inputs to a multiply-and-accumulate array of the neural network accelerator.

14. The one or more non-transitory computer-readable media of claim 13, wherein the aggregation operation comprises a cumulative sum operation along the dimension of the tensor.

15. The one or more non-transitory computer-readable media of claim 13, wherein the mask tensor is a lower-triangular binary matrix comprising ones on and below a diagonal and zeros above the diagonal.

16. The one or more non-transitory computer-readable media of claim 13, wherein the one or more machine-readable configurations configure the multiply-and-accumulate array of the neural network accelerator to perform matrix-to-matrix multiplication of the tensor and the mask tensor.

17. The one or more non-transitory computer-readable media of claim 13, wherein the aggregation operation comprises a reduce sum operation along the dimension of the tensor.

18. The one or more non-transitory computer-readable media of claim 13, wherein the mask tensor is a vector mask comprising a saturating pattern of ones.

19. A method for compiling a neural network, comprising:
receiving a processing graph of the neural network comprising connected neural network operations;
identifying an aggregation operation along a dimension of a tensor in the connected neural network operations of the processing graph;
generating a mask tensor corresponding to the aggregation operation; and
determining one or more machine-readable configurations for configuring a neural network accelerator to perform the aggregation operation using the tensor and the mask tensor as inputs to a multiply-and-accumulate array of the neural network accelerator.

20. The method of claim 19, wherein the connected neural network operations comprises a plurality of operations associated with a state space model, and the plurality of operations associated with the state space model includes the aggregation operation.
